(19) United States
(12) Patent Application Publication
(10) Pub. No.: US 2014/0370337 A1
(43) Pub. Date: Dec. 18, 2014

(54) ELECTRODE, SECONDARY BATTERY, BATTERY PACK, ELECTRIC VEHICLE, ELECTRIC POWER STORAGE SYSTEM, ELECTRIC POWER TOOL, AND ELECTRONIC APPARATUS

(71) Applicant: Sony Corporation, Tokyo (JP)

(72) Inventors: Takaaki MATSUI, Fukushima (JP); Takehiko ISHII, Fukushima (JP)

(21) Appl. No.: 14/297,178

(22) Filed: Jun. 5, 2014

(30) Foreign Application Priority Data
Jun. 14, 2013 (JP) 2013-125643

(51) Int. Cl. H01M 4/485

(52) U.S. Cl. CPC H01M 4/485
USPC 429/61; 429/233; 429/223; 429/221; 429/220

(57) ABSTRACT

A secondary battery includes a cathode, an anode, and a non-aqueous electrolytic solution. The cathode includes a cathode current collector, and a cathode active material layer provided on the cathode current collector. The cathode active material layer is configured of a single layer and includes a plurality of cathode active material particles. When the cathode active material layer is divided, at one or more arbitrary positions, into two or more layers, an average particle size of the cathode active material particles in an uppermost layer is smaller than an average particle size of the cathode active material particles in a lowermost layer in the two or more layers of the divided cathode active material layer.

### CROSS REFERENCES TO RELATED APPLICATIONS

The present application claims priority to Japanese Priority Patent Application JP 2013-125643 filed in the Japan Patent Office on Jun. 14, 2013, the entire content of which is hereby incorporated by reference.

### BACKGROUND

The present application relates to an electrode, for a secondary battery, that includes a current collector and an active material layer, and to a secondary battery that uses the electrode for a secondary battery. The present application also relates to a battery pack, an electric vehicle, an electric power storage system, an electric power tool, and an electronic apparatus that use the secondary battery.

In recent years, various electronic apparatuses such as a mobile phone and a personal digital assistant (PDA) have been widely used, and it has been demanded to further reduce size and weight of the electronic apparatuses and to achieve their long life. Accordingly, as an electric power source for the electronic apparatuses, a battery, in particular, a small and light-weight secondary battery capable of achieving high energy density has been developed.

In these days, it has been considered to apply such a secondary battery to various other applications in addition to the foregoing electronic apparatuses. Examples of such other applications may include a battery pack attachably and detachably mounted on an electronic apparatuses, etc., an electric vehicle such as an electric automobile, an electric power storage system such as a home electric power server, and an electric power tool such as an electric drill.

Secondary batteries utilizing various charge-discharge principles to obtain battery capacity have been proposed. In particular, a secondary battery obtaining battery capacity by utilizing insertion and extraction of an electrode reactant or utilizing precipitation and dissolution of an electrode reactant has attracted attention, since such a secondary battery provides higher energy density than lead batteries, nickel-cadmium batteries, etc.

The secondary battery includes a cathode, an anode, and an electrolytic solution. The cathode includes a cathode active material layer provided on a cathode current collector. The cathode active material layer includes a cathode active material related to electric charge and discharge reaction. A configuration of the cathode gives large influence on battery characteristics of the secondary battery. Therefore, various considerations have been made for the configuration of the cathode.

Specifically, in order to achieve superior electric discharge characteristics in a wide range of temperature, in a cathode mixture layer that includes a plurality of layers, a specific area of active material powder increases in a direction approaching an anode (for example, see Japanese Unexamined Patent Application Publication No. 2003-077482). In order to improve durability of a battery, first and second active material layers are laminated on a surface of a current collector in order from a surface of an active material layer, and an average particle size of second active materials is allowed to be smaller than an average particle size of first active materials (for example, see Japanese Unexamined Patent Application Publication No. 2006-210003). In order to achieve superior cycle characteristics, two cathode mixture layers that include cathode active material particles and a binder are laminated and a specific surface area of the cathode active material particles in an upper layer is allowed to be smaller than a specific surface area of the cathode active material particles in a lower layer (for example, see Japanese Patent No. 3719312).

### SUMMARY

Higher performance and larger number of functions have been achieved in electronic apparatuses, etc. In accordance therewith, frequency and application of use of such an electronic apparatus etc. have been increased. Therefore, a secondary battery tends to be frequently charged and discharged. Therefore, there is still a room for improvement in battery characteristics of the secondary battery.

It is desirable to provide an electrode for a secondary battery, a secondary battery, a battery pack, an electric vehicle, an electric power storage system, an electric power tool, and an electronic apparatus that are capable of achieving superior battery characteristics.

According to an embodiment of the present application, there is provided an electrode including: a current collector; and an active material layer provided on the current collector. The active material layer is configured of a single layer and includes a plurality of active material particles. When the cathode active material layer is divided, at one or more arbitrary positions, into two or more layers, an average particle size of the cathode active material particles in an uppermost layer is smaller than an average particle size of the cathode active material particles in a lowermost layer in the two or more layers of the divided cathode active material layer.

According to an embodiment of the present application, there is provided a secondary battery including: a cathode; an anode; and a non-aqueous electrolytic solution. The cathode includes: a cathode current collector; and a cathode active material layer provided on the cathode current collector. The cathode active material layer is configured of a single layer and includes a plurality of cathode active material particles. When the cathode active material layer is divided, at one or more arbitrary positions, into two or more layers, an average particle size of the cathode active material particles in an uppermost layer is smaller than an average particle size of the cathode active material particles in a lowermost layer in the two or more layers of the divided cathode active material layer.

According to an embodiment of the present application, there is provided a battery pack including: a secondary battery; a control section configured to control operation of the secondary battery; and a switch section configured to switch the operation of the secondary battery according to an instruction of the control section. The secondary battery includes a cathode, an anode, and a non-aqueous electrolytic solution. The cathode includes a cathode current collector, and a cathode active material layer provided on the cathode current collector. The cathode active material layer is configured of a single layer and includes a plurality of cathode active material particles. When the cathode active material layer is divided, at one or more arbitrary positions, into two or more layers, an average particle size of the cathode active material particles in an uppermost layer is smaller than an average particle size of the cathode active material particles in a lowermost layer in the two or more layers of the divided cathode active material layer.

According to an embodiment of the present application, there is provided an electric vehicle including: a secondary battery; a conversion section configured to convert electric power supplied from the secondary battery into drive power; a drive section configured to operate according to the drive power; and a control section configured to control operation of the secondary battery. The secondary battery includes a cathode, an anode, and a non-aqueous electrolytic solution. The cathode includes a cathode current collector, and a cathode active material layer provided on the cathode current collector. The cathode active material layer is configured of a single layer and includes a plurality of cathode active material particles. When the cathode active material layer is divided, at one or more arbitrary positions, into two or more layers, an average particle size of the cathode active material particles in an uppermost layer is smaller than an average particle size of the cathode active material particles in a lowermost layer in the two or more layers of the divided cathode active material layer.

According to an embodiment of the present application, there is provided an electric power storage system including: a secondary battery; one or more electric devices configured to be supplied with electric power from the secondary battery; and a control section configured to control supplying of the electric power from the secondary battery to the one or more electric devices. The secondary battery includes a cathode, an anode, and a non-aqueous electrolytic solution. The cathode includes a cathode current collector, and a cathode active material layer provided on the cathode current collector. The cathode active material layer is configured of a single layer and includes a plurality of cathode active material particles. When the cathode active material layer is divided, at one or more arbitrary positions, into two or more layers, an average particle size of the cathode active material particles in an uppermost layer is smaller than an average particle size of the cathode active material particles in a lowermost layer in the two or more layers of the divided cathode active material layer.

According to an embodiment of the present application, there is provided an electric power tool including: a secondary battery; and a movable section configured to be supplied with electric power from the secondary battery. The secondary battery includes a cathode, an anode, and a non-aqueous electrolytic solution. The cathode includes a cathode current collector, and a cathode active material layer provided on the cathode current collector. The cathode active material layer is configured of a single layer and includes a plurality of cathode active material particles. When the cathode active material layer is divided, at one or more arbitrary positions, into two or more layers, an average particle size of the cathode active material particles in an uppermost layer is smaller than an average particle size of the cathode active material particles in a lowermost layer in the two or more layers of the divided cathode active material layer.

According to an embodiment of the present application, there is provided an electronic apparatus including a secondary battery as an electric power supply source. The secondary battery includes a cathode, an anode, and a non-aqueous electrolytic solution. The cathode includes a cathode current collector, and a cathode active material layer provided on the cathode current collector. The cathode active material layer is configured of a single layer and includes a plurality of cathode active material particles. When the cathode active material layer is divided, at one or more arbitrary positions, into two or more layers, an average particle size of the cathode active material particles in an uppermost layer is smaller than an average particle size of the cathode active material particles in a lowermost layer in the two or more layers of the divided cathode active material layer.

Here, the above-described terms refer to as follows. “Average particle size” refers to a so-called median diameter (D50: μm). The wording “be configured of a single layer” refers to that the active material layer is formed in one film formation step, and therefore, an interface is not present in that active material layer. The wording “be divided” refers to that the active material layer is divided only conceptually, since the active material layer is a single layer as described above. Therefore, the uppermost and lowermost layers are each not a layer that is separated physically (an actual layer that causes an interface) but is a layer that is sectioned conceptually in a single layer (a hypothetical layer that causes no interface). However, it goes without saying that it is necessary to separate the active material layer of a single layer when average particle sizes of the active material particles in the respective sectioned layers are examined. In this case, the average particle size of the active material particles is examined for each of the layers (the first and second layers) that are physically separated.

According to the electrode or the secondary battery of the embodiments of the present application, in the active material layer of a single layer, the average particle size of the active material particles in the lowermost layer that is farther from the current collector is smaller than the average particle size of the active material particles in the uppermost layer that is closer to the current collector. Therefore, it is possible to achieve superior battery characteristics. Also according to the battery pack, the electric vehicle, the electric power storage system, the electric power tool, and the electronic apparatus of the embodiments of the present application, it is possible to achieve a similar effect.

It is to be understood that both the foregoing general description and the following detailed description are exemplary, and are intended to provide further explanation of the technology as claimed.

Additional features and advantages are described herein, and will be apparent from the following Detailed Description and the figures.

### BRIEF DESCRIPTION OF THE FIGURES

The accompanying drawings are included to provide a further understanding of the disclosure, and are incorporated in and constitute a part of this specification. The drawings illustrate embodiments and, together with the specification, serve to explain the principles of the technology.

FIG. 1 is a cross-sectional view illustrating a configuration of an electrode for a secondary battery according to an embodiment of the present application.

FIG. 2 is a cross-sectional view for explaining distribution of an average particle size of active material particles in an active material layer.

FIG. 3 is a cross-sectional view for explaining distribution of another average particle size of the active material particles in the active material layer.

FIG. 4 is a cross-sectional view illustrating a configuration of an electrode for a secondary battery in a comparative example.

FIG. 5 is a cross-sectional view illustrating a configuration of a secondary battery (of a cylindrical type) that uses the electrode for the secondary battery according to an embodiment of the present application.

FIG. 6 is a cross-sectional view illustrating an enlarged part of a spirally wound electrode body illustrated in FIG. 5.

FIG. 7 is a perspective view illustrating a configuration of another secondary battery (of a laminated film type) that uses the electrode for the secondary battery according to an embodiment of the present application.

FIG. 8 is a cross-sectional view taken along a line VIII-VIII of a spirally wound electrode body illustrated in FIG. 7.

FIG. 9 is a block diagram illustrating a configuration of an application example (a battery pack) of the secondary battery.

FIG. 10 is a block diagram illustrating a configuration of an application example (an electric vehicle) of the secondary battery.

FIG. 11 is a block diagram illustrating a configuration of an application example (an electric power storage system) of the secondary battery.

FIG. 12 is a block diagram illustrating a configuration of an application example (electric power tool) of the secondary battery.

### DETAILED DESCRIPTION

An embodiment of the present application will be described below in detail referring to the drawings. Description will be given in the following order.

### 1. Electrode for Secondary Battery

### 2. Secondary Battery

2-1. Lithium Ion Secondary Battery (Cylindrical Type)

2-2. Lithium Ion Secondary Battery (Laminated Film Type)

2-3. Lithium Metal Secondary Battery

### 3. Applications of Secondary Battery

3-1. Battery Pack

3-2. Electric Vehicle

3-3. Electric Power Storage System

3-4. Electric Power Tool

[1. Electrode for Secondary Battery]

First, description will be provided of an electrode for a secondary battery (hereinafter, may be also simply referred to as “electrode”) according to an embodiment of the present application. The electrode may be used as a cathode or as an anode in a secondary battery.

[General Configuration of Electrode]

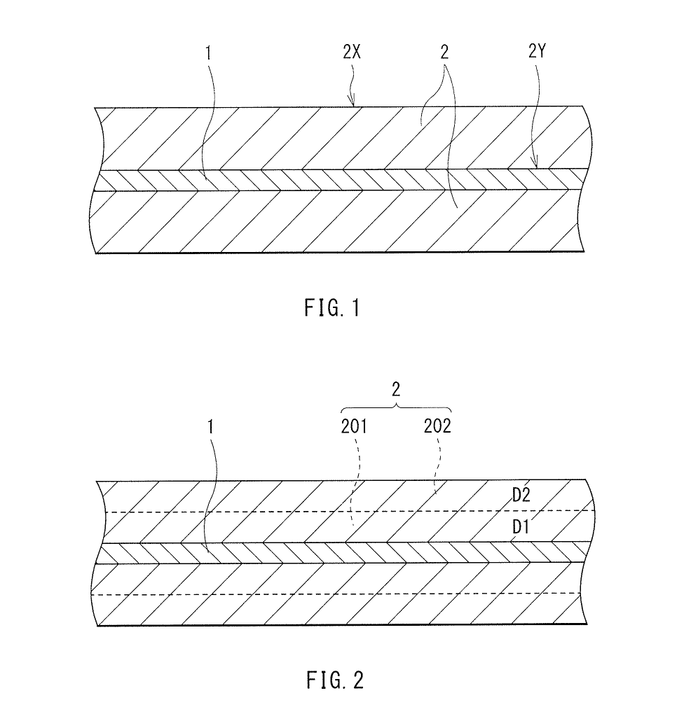

FIG. 1 illustrates a cross-sectional configuration of the electrode. The electrode includes a current collector 1 and an active material layer 2. In this description, description will be provided of a case in which the electrode is used as a cathode as an example.

[Current Collector]

The current collector 1 may include, for example, one or more of electrically-conductive materials. The types of the electrically-conductive materials are not particularly limited. Examples of the electrically-conductive material may include metal materials such as aluminum (Al), nickel (Ni), and stainless still. It is to be noted that the current collector 1 may be configured of a single layer or of multiple layers.

[Active Material Layer]

The active material layer 2 is provided on the current collector 1. The active material layer includes a top surface 2X and a bottom surface 2Y. Specifically, the bottom surface 2Y of the active material layer 2 is in contact with a surface of the current collector 1. However, the active material layer 2 may be provided only on one surface of the current collector 1, and may be provided on both surfaces thereof. FIG. 1 shows a case where the active material layers 2 are provided on both surfaces of the current collector 1.

The active material layer 2 is configured of a single layer. The wording “be configured of a single layer” refers to that the active material layer 2 is formed in one film formation step, and therefore, an interface 3X (see FIG. 4) described later is not present in the active material layer 2.

In order to examine whether or not the active material layer 2 is configured of a single layer, for example, a cross-section of the active material layer 2 may be observed with the use of one of various microscopes, and then, it may be determined whether or not the interface 3X is observable in a result of the observation (in an observed image). As such a microscope, for example, a scanning electron microscope (SEM), etc. may be used. When the active material layer 2 is formed in two or more film formation steps, the interface 3X is observed between adjacent layers. Accordingly, it is confirmed that the active material layer 2 is configured of multiple layers. On the other hand, when the active material layer 2 is formed in one film formation step, the interface 3X is not observed. Accordingly, it is confirmed that the active material layer 2 is configured of a single layer. It is to be noted that whether or not the interface 3X is observable in the observed image hardly depends on observation conditions such as magnification. Therefore, any observation condition may be set as long as observation is allowed to be performed at a magnification that allows at least the entire active material layer 2 in a thickness direction to be observed. The above-described “thickness direction” refers to a direction corresponding to a thickness of the active material layer 2, and is a top-bottom direction in FIG. 1.

The active material layer 2 includes a plurality of active material particles that are capable of inserting and extracting an electrode reactant. The active material particles include one or more of electrode materials. A content of the active material particles in the active material layer 2 is not particularly limited; however, may be, for example, from 40 wt % to 99 wt % both inclusive. “Electrode reactant” refers to a substance related to an electrode reaction. For example, an electrode reactant in a case where battery capacity is obtained utilizing insertion and extraction of lithium (Li) may be lithium.

However, the active material layer 2 may further include one or more of other materials. Examples of such other materials may include a binder and an electric conductor.

The electrode material may be preferably a lithium-containing compound, and may be more preferably a lithium transition metal composite oxide since high energy density is achieved thereby. “Lithium-containing compound” refers to a compound that includes lithium (Li) as a constituent element. “Lithium transition metal composite oxide refers to an oxide that includes lithium and one or more transition metal elements as constituent elements, and has a crystal structure of a bedded salt type. The type of the transition metal element is not particularly limited. However, in particular, the transition metal element may be preferably one or more of cobalt (Co), nickel (Ni), manganese (Mn), iron (Fe), etc., and may be more preferably cobalt, since a higher voltage is achieved thereby.

A composition of the lithium transition metal composite oxide is not particularly limited as long as the above-described specific types of constituent elements (lithium, transition metal element, and oxygen) are included, and the crystal structure of the bedded salt type is secured. In particular, the lithium transition metal composite oxide may preferably include one or more of compounds represented by following Formula (1) since higher energy density is achieved thereby.

LiₐNi_{b}M_{c}O_{d} (1)

(M is one or more of cobalt (Co), iron (Fe), manganese (Mn), copper (Cu), zinc (Zn), aluminum (Al), chromium (Cr), vanadium (V), titanium (Ti), magnesium (Mg), and zirconium (Zr), and a to d satisfy 0.8<a<1.2, 0.45≦b≦1, 0≦c≦1, 0≦b+c≦1, and 0<d<3.)

The compound represented by Formula (1) is nickel-based lithium transition metal composite oxide. As can be clearly seen from a possible range of a value of “a”, this compound may be a so-called “lithium-rich (a>1)” compound. As can be clearly seen from a possible range of values of “b” and “c”, the above-described compound includes nickel (Ni) as transition metal element, but may not necessarily include transition metal element (M) other than nickel. It is to be noted that the type of M is not particularly limited as long as M is one or more of the above-described elements including Co, etc.

Specific examples of the nickel-based lithium transition metal composite oxide may include LiNiO₂ and LiNi_{0.5}CO_{0.2}Mn_{0.3}O₂. The nickel-based lithium transition metal composite oxide may be other compound that has a composition expressed by Formula (1).

It is to be noted that the active material particles may further include one or more other electrode materials as long as the active material particles include the above-described lithium-containing compound as the electrode material. Other electrode material may be preferably, for example, other lithium-containing compound (except for that corresponding to the above-described lithium-containing compound) since high energy density is achieved thereby.

Specifically, examples of the other electrode material may include lithium transition metal composite oxide that has a spinel-type crystal structure, and lithium transition metal phosphate compound that has an olivine-type crystal structure. Specific examples of the lithium transition metal composite oxide that has the spinel-type crystal structure may include LiMn₂O₄, or may be other compounds. “Lithium transition metal phosphate compound” refers to phosphate compound that includes lithium and one or more transition metal elements as constituent elements. Specific examples of the lithium transition metal phosphate compound may include LiFePO₄, LiMnPO₄, and LiFe_{0.5}Mn_{0.5}PO₄, or may be other compounds.

Other than the above-described materials, examples of the other electrode material may include one or more of oxides, disulfides, chalcogenides, and electrically-conductive polymers. Examples of the oxides may include titanium oxide, vanadium oxide, and manganese dioxide. Examples of the disulfides may include titanium disulfide and molybdenum sulfide. Examples of the chalcogenides may include niobium selenide. Examples of the electrically-conductive polymers may include sulfur, polyaniline, and polythiophene. It goes without saying that the other electrode material may be a material other than the above-described materials.

Example of the binder may include one or more of synthetic rubbers and polymer materials. Examples of the synthetic rubber may include styrene-butadiene-based rubber, fluorine-based rubber, and ethylene-propylene-diene. Examples of the polymer material may include polyvinylidene fluoride and polyimide. A content of the binder in the active material layer 2 is not particularly limited, but may be, for example, from 0.1 wt % to 30 wt % both inclusive.

Example of the electric conductor may include one or more of carbon materials, etc. Example of the carbon materials may include carbide, carbon black, acethylene black, and Ketjen black. It is to be noted that the cathode electric conductor may be other material such as a metal material or an electrically-conductive polymer as long as the material has electrically-conductive characteristics. A content of the electric conductor in the active material layer 2 is not particularly limited, but may be, for example, from 0.1 wt % to 30 wt % both inclusive.

In particular, the active material layer 2 may preferably include a binder. One reason for this is that a plurality of active material particles are easily fixed in the active material layer 2, in other words, a position of each active material particle is easily fixed in the active material layer 2. Accordingly, distribution of the average particle size of the active material particles which will be described later is easily maintained or controlled.

It is to be noted that the conditions such as thickness (μm) and volume density (g/cm³) related to the active material layer 2 are not particularly limited.

[Distribution of Average Particle Sizes of Active Material Particles in Active Material Layer]

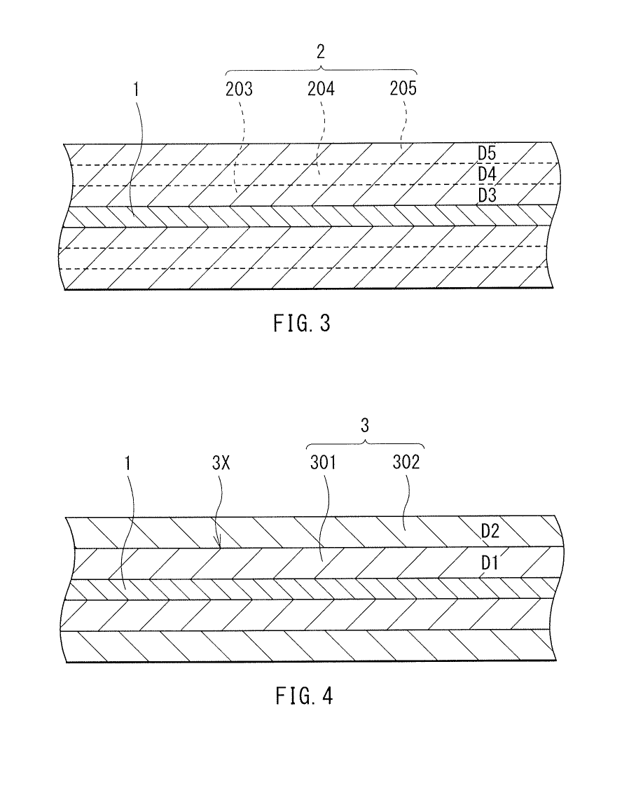

FIGS. 2 and 3 are provided for explaining distribution of particle sizes of the active material particles in the active material layer 2, and each correspond to a cross-sectional configuration of an electrode corresponding to that in FIG. 1. FIG. 4 illustrates a cross-sectional configuration of an electrode in a comparative example. The electrode in the comparative example has a configuration similar to a configuration of the electrode (FIG. 1) of the present embodiment except that the electrode includes an active material layer 3 configured of multiple layers instead of the active material layer 2 configured of a single layer.

In the electrode according to the present embodiment, distribution of the average particle sizes of the active material particles in the active material layer 2 satisfies following conditions.

The active material layer 2 includes a plurality of active material particles. Therefore, the plurality of active material particles are dispersed in the active material layer 2 configured of a single layer. However, the distribution of the average particle sizes of the active material particles in the active material layer 2 has gradient in the thickness direction. More specifically, the average particle size (μm) of the active material particles is smaller in a region far from to the current collector 1 than in a region close to the current collector 1. “Average particle size” refers to a so-called median diameter (D50), and this is applicable hereinafter.

In order to confirm that the distribution of the average particle sizes of the active material particles has the above-described gradient, for example, the active material layer 2 in the thickness direction is divided into two or more, and the average particle size of the active material particles is measured in different positions in the active material layer 2, and thereafter, measurement results thereof may be compared with each other.

Specifically, for example, when the active material layer 2 is divided into two in the thickness direction, first, part (an upper layer) of the active material layer 2 is peeled off with use of Kapton tape or the like. Thereafter, a plurality of active material particles included in the upper layer is taken out and an average particle size thereof is measured. Subsequently, rest (a lower layer) of the active material layer 2 is peeled off from the current collector 1. Thereafter, a plurality of active material particles included in the lower layer are taken out, and an average particle size thereof is measured. Lastly, the average particle size in the upper layer is compared to the average particle size in the lower layer. When the average particle size in the upper layer is smaller than the average particle size in the lower layer, the distribution of the average particle sizes of the active material particles has gradient.

It is to be noted that the thickness of each of the lower and upper layers is not particularly limited. One reason for this is that, when the distribution of the average particle sizes of the active material particles has gradient, the average particle size in the upper layer is smaller than the average particle size in the lower layer independently from the thicknesses of the lower and upper layers. When the upper layer is peeled off from the active material layer 2, for example, the upper layer may be dissolved to be removed with use of, for example, cotton impregnated with an organic solvent such as N-methyl-2-pyrolidone instead of peeling off the upper layer to be removed with the use of the Kapton tape.

In this example, a procedure of taking out the plurality of active material particles from the upper layer may be, for example, as follows. First, the upper layer is picked on a watch glass. Thereafter, the picked upper layer is dissolved in organic solvent to make slurry. The type of the organic solvent is not particularly limited, but may be, for example, one or more of N-methyl-2-pyrolidone, etc. Subsequently, the slurry may be heated, for example, with the use of a drying machine, etc. As a result, the organic solvent in the slurry is volatized, and therefore, solid is left. The heating condition is not particularly limited, but may be, for example, 90° C.×5 hours. Subsequently, the solid is fired in air or in oxygen with the use of a firing furnace. Thus, materials such as the binder and the electric conductor included in the solid are burned to be removed. The firing condition is not particularly limited, but may be, for example, 700° C.×10 minutes. Subsequently, the residual substance after the firing is picked in a mortar. Thereafter, the residual substance is crushed, and thereby, a plurality of active material particles are obtained.

It goes without saying that the procedure of taking out a plurality of active material particles from the lower layer is similar to the procedure of taking out the plurality of active material particles from the upper layer.

It is to be noted that the active material layer 2 may be divided not limitedly into two, but may be divided into three or more. Also when the active material layer 2 is divided into three or more, an average particle size of the active material particles in a layer (an uppermost layer) that is farthest from the current collector 1 may be compared to an average particle size of the active material particles in a layer (a lowermost layer) that is closest to the current collector 1. When the former average particle size is smaller than the latter average particle size, the distribution of the average particle sizes of the active material particles has gradient.

The average particle size of the active material particles has gradient as described above. Accordingly, the average particle size of the active material particles varies depending on a position in the thickness direction.

In detail, as shown in FIG. 2, for example, the active material layer 2 may be divided (in this example, into two) in the thickness direction. Accordingly, the active material layer 2 includes a lower layer 201 (a first layer) and an upper layer 202 (a second layer) in order from the current collector 1. The wording “be divided” refers to a state where the active material layer 2 is divided merely conceptually since the active material layer 2 is configured of a single layer as described above. Therefore, the lower layer 201 and the upper layer 202 are not two layers that are physically separated (actual layers that cause the interface 3X which will be described later), but are two layers that are conceptually sectioned in a single layer (hypothetical layers that do not cause the interface 3X). However, it goes without saying that it may be necessary to separate the active material layer 2 configured of a single layer into two layers (the lower layer 201 and the upper layer 202) when the average particle size of the active material particles is examined in each of the lower layer 201 and the upper layer 202. In this case, the average particle size of the active material particles are examined for each of the two layers (the lower layer 201 and the upper layer 202) that are physically separated.

In the active material layer 2 that conceptually includes two layers (the lower layer 201 and the upper layer 202) in such a manner, although the active material layer 2 is configured of a single layer, an average particle size D2 of the active material particles in the upper layer 202 is smaller than an average particle size D1 of the active material particles in the lower layer 201.

Some reasons why the distribution of the average particle sizes of the active material particles satisfies the above-described condition in the active material layer 2 configured of a single layer are as follows.

When an average particle size D of the active material particles is uniformly large (for example, D=D1), a reaction area with respect to an electrolyte solution is small. Therefore, degradation of battery capacity in cycles (when charge process and discharge process are repeatedly performed) is suppressed. However, diffusion speed of the electrode reactant is slow. Therefore, increase in electric resistance is accelerated in cycles. On the other hand, when the average particle size D of the active material particles is uniformly small (for example, D=D2), the diffusion speed of the electrode reactant is fast, and the electrode reactant is smoothly received between opposed electrodes. Therefore, increase in electric resistance in cycles is suppressed. However, the reaction area with respect to the electrolytic solution is large. Therefore, degradation of battery capacity in cycles is accelerated. Accordingly, a trade-off relationship is caused in which one is improved while the other is degraded, when the battery capacity and the electric resistance are to be adjusted by varying the average particle size of the active material particles in the active material layer 2 configured of a single layer.

In this example, in order to resolve the above-described trade-off relationship, one option may be to use an electrode in a comparative example shown in FIG. 4. In a case of forming the active material layer 3, a lower layer 301 (D=D1) that has a relatively-large average particle size D of the active material particles is formed, and then, an upper layer 302 (D=D2) that has a relatively-small average particle size D of the active material particles is formed separately on the lower layer 301. As a result, high battery capacity is maintained in cycles in the lower layer 301, and increase in electric resistance in cycles is suppressed in the upper layer 302. Therefore, it is likely that the trade-off relationship is resolved. However, in the active material layer 3 configured of multiple layers, the interface 3X is caused between the lower layer 301 and the upper layer 302. Therefore, electric resistance is increased due to so-called interface resistance (which may also be called interlayer resistance or contact resistance). Accordingly, electric resistance does not sufficiently decrease in the electrode as a whole. Therefore, the trade-off relationship still remains.

On the other hand, in the electrode according to the present embodiment shown in FIG. 2, high battery capacity is maintained in cycles in the portion (the lower layer 201), of the active material layer 2, that is in a position closer to the current collector 1 and has a relatively-large average particle size D of the active material particles. Also, electrode reactant having high diffusion speed is present on a surface of the active material particles in a portion (the upper layer 202), of the active material layer 2, that is in a position farther from the current collector 1 and has a relatively-small average particle size D of the active material particles. Accordingly, the electrode reactant is smoothly received between the opposed electrodes. Therefore, increase in electric resistance is suppressed. Also, the above-described interface 3X is not caused in the active material layer 2 configured of a single layer. Accordingly, increase in electric resistance resulting from interface resistance is not caused. Therefore, the electric resistance of the electrode as a whole is suppressed to be low. Accordingly, the above-described trade-off relationship is resolved. As a result, high battery capacity is achieved while suppressing the electric resistance of the electrode as a whole to be low.

It is to be noted that when the active material layer 2 is divided into two, thicknesses of the lower layer 201 and the upper layer 202 are not particularly limited. Specifically, the thickness of the lower layer 201 may be the same as or may be different from the thickness of the upper layer 202. One reason for this is that similar advantage is achievable independently of the relationship between the thicknesses of the lower layer 201 and the upper layer 202 as long as the distribution of the average particle sizes of the active material particles in the active material layer 2 configured of a single layer satisfies the above-described condition. However, it may be preferable that the active material layer 2 be equally divided into two to allow the thickness of the lower layer 201 to be equal to the thickness of the upper layer 202 since higher effect is achieved thereby. It goes without saying that, when the active material layer 2 is equally divided into two, the thickness of the lower layer 201 is not necessarily exactly the same as the thickness of the upper layer 202, and the thicknesses may be different from each other in some degree due to measurement error, etc.

In particular, the distribution of the average particle sizes of the active material particles in the active material layer 2 may preferably satisfy the following condition.

In details, as shown in FIG. 3, the active material layer 2 may be divided (in this example, into three) in the thickness direction, for example. As a result, the active material layer 2 includes a lower layer 203 (a third layer), an intermediate layer 204 (a fourth layer), and an upper layer 205 (a fifth layer) in order from the current collector 1. The wording “be divided (into three)” refers to a state (conceptual division of the active material layer 2) similar to that of “be divided (into two)” described above.

In such a manner, the active material layer 2 includes three conceptual layers (the lower layer 203, the intermediate layer 204, and the upper layer 205). In this case, although the active material layer 2 is configured of a single layer, an average particle size D5 of the active material particles in the upper layer 205 may be preferably smaller than an average particle size D3 of the active material particles in the lower layer 203. One reason for this is that the above-described balance between the battery capacity and the electric resistance is appropriately adjusted, and therefore, a higher effect is achieved. In this example, one reason for focusing on only two layers (the lower layer 203 and the upper layer 205) out of the three layers is that a difference in average particle size of the active material particles is likely to be apparent between a portion near the top surface 2X and a portion near the bottom surface 2Y.

In this case, an average particle size D4 of the active material particles in the intermediate layer 204 may be preferably smaller than the average particle size D3 of the active material particles in the lower layer 203, and the average particle size D5 of the active material particles in the upper layer 205 may be preferably smaller than the average particle size D4 of the active material particles in the intermediate layer 204. One reason for this is that the balance between the battery capacity and the electric resistance is appropriately adjusted, and therefore, a further higher effect is achieved.

In particular, the average particle size D of the active material particles in the active material layer 2 may preferably decrease gradually in a direction away from the current collector 1 in the thickness direction since a remarkably high effect is achieved thereby.

It is to be noted that, when the active material layer 2 is divided into three, the thicknesses of the lower layer 203, the intermediate layer 204, and the upper layer 205 are not particularly limited as in the case of dividing the active material layer 2 into two. However, in particular, it may be preferable that the active material layer 2 be equally divided into three. Also in this case, the thicknesses of the lower layer 203, the intermediate layer 204, and the upper layer 205 may be different from one another in some degree.

An electrode with an average particle size of the active material particles in the active material layer 2 that satisfies the above-described condition is formed by forming the active material layer 2 in which the average particle size D is uniform in the entire layer, and then compressing the active material layer 2 as described later. In this case, a molding process may be performed at the same time of performing the compression process. By the compression process, part of a plurality of active material particles is crushed. Therefore, a particle size of the crushed active material particles is smaller than a particle size thereof before the crushing process.

It is to be noted that particle strength of the active material particles is not particularly limited. However, the particle strength may be preferably relatively soft in order to allow the average particle size of the active material particles to be easily varied in accordance with the above-described compression process and thereby to easily control the average particle size with high accuracy.

Specifically, when the active material layer 2 is divided into two, for example, the lower layer 201 is taken out from the active material layer 2 and is subjected to a uniaxial pressing process (at pressure of 30 MPa) in the thickness direction with the use of a roll press machine. Variation (hereinafter, referred to as “frequency variation ΔF”) before and after the pressing process in frequency (%) of minimum peak detected by measuring particle size distribution in the lower layer 201 is not particularly limited, but may be preferably from 0.9% to 16.1% both inclusive, and may be more preferably from 1.1% to 15.8% both inclusive. One reason for this is that the active material particle is difficult to be crushed by the above-described compression process when the frequency variation ΔF is smaller than 1.1%. Another reason is that the active material particle is excessively crushed and therefore the active material layer 2 easily fall from the current collector 1 due to the compression process when the frequency variation ΔF is larger than 15.8%.

“Frequency variation ΔF” is an index that represents softness of the active material particle. As a value of the frequency variation ΔF is larger, the active material particle is easier to be crushed. “Particle size distribution” refers to so-called volume distribution. These matters are similarly applicable also in description below. In the particle size distribution, a horizontal axis indicates a particle size (μm) and a vertical axis indicates frequency (%). In determining the frequency variation ΔF, particle size distribution in the lower layer 201 is measured before the pressing process, and then, a peak with minimum frequency is determined out of one or more peaks. Subsequently, the particle size distribution in the lower layer 201 is measured after the pressing process, and then, a peak with minimum frequency is determined in a manner similar to that before the pressing process. It is to be noted that, in any case of determining the minimum peak, when only one peak is detected, the detected peak is considered to be the minimum peak. Based on the result, frequency variation ΔF (%)=(frequency of minimum peak after pressing process)−(frequency of minimum peak before pressing process) is calculated.

When the active material layer 2 is divided into three, for example, the frequency variation ΔF in the lower layer 203 is not particularly limited for a reason similar to that in the case of dividing the active material layer 2 into two. However, the frequency variation ΔF in the lower layer 203 may be preferably from 0.9% to 16.1% both inclusive, and may be more preferably from 1.1% to 15.8% both inclusive. A procedure of measuring the frequency variation ΔF in the lower layer 203 is similar to that in the case where the active material layer 2 is divided into two.

[Other Conditions Related to Configuration of Active Material Layer]

The configuration of the active material layer 2 may preferably satisfy also following conditions in addition to the above-described condition since the balance between the battery capacity and the electric resistance is adjusted appropriately thereby, and therefore, a higher effect is achieved.

When the active material layer 2 is divided into two in the thickness direction (see FIG. 2), following five conditions (first to fifth conditions) may be preferably satisfied.

As the first condition, the active material layer 2 has a thickness from 80 μm to 180 μm both inclusive. This “thickness” refers to the thickness of the active material layer 2 on one surface side of the current collector 1. Therefore, when the active material layers 2 are provided on both surfaces of the current collector 1, “thickness” refers to the thickness of each of the active material layers 2.

As the second condition, volume density of the active material layer 2 is from 2.7 g/cm³ to 3.6 g/cm³ both inclusive. This volume density is calculated by dividing weight (g) of the active material layer 2 by volume (cm³) thereof.

As the third condition, particle size distribution of the active material particles in the active material layer 2 is measured. By this particle size distribution measurement, two peaks are detected. The two peaks are a peak P1 (a first peak) that has relatively-large frequency (%) and a peak P2 (a second peak) that has relatively-small frequency (%). Where the frequency of the peak P1 is F1 and the frequency of the peak P2 is F2, a ratio F1/F2 between the frequencies F1 and F2 is from 0.2 to 7 both inclusive.

As the fourth condition, particle size distribution of the active material particles in the lower layer 201 is measured. By this particle size distribution measurement, two peaks are detected. The two peaks are a peak P3 (a third peak) that has relatively-large frequency (%) and a peak P4 (a fourth peak) that has relatively-small frequency (%). Where the frequency of the peak P3 is F3 and the frequency of the peak P4 is F4, a ratio F3/F4 between the frequencies F3 and F4 is from 0.35 to 9 both inclusive.

As the fifth condition, a ratio (F1/F2)/(F3/F4) of the above-described ratio F1/F2 and the above-described ratio F3/F4 is from 0.57 to 0.79 both inclusive.

Alternatively, when the active material layer 2 is divided into three in the thickness direction (see FIG. 3), following five conditions (sixth to tenth conditions) may be preferably satisfied.

The sixth to eighth conditions are similar to the first to third conditions described above.

As the ninth condition, particle size distributions of the active material particles in the lower layer 203 and the intermediate layer 204 are measured. By these particle size distribution measurements, two peaks are detected. The two peaks are a peak P5 (a fifth peak) that has relatively-large frequency (%) and a peak P6 (a sixth peak) that has relatively-small frequency (%). Where the frequency of the peak P5 is F5 and the frequency of the peak P6 is F6, a ratio F5/F6 between the frequencies F5 and F6 is from 0.27 to 7.65 both inclusive.

As the tenth condition, particle size distribution of the active material particles in the lower layer 203 is measured. By this particle size distribution measurement, two peaks are detected. The two peaks are a peak P7 (a seventh peak) that has relatively-large frequency (%) and a peak P8 (an eighth peak) that has relatively-small frequency (%). Where the frequency of the peak P7 is F7 and the frequency of the peak P8 is F8, a ratio F7/F8 between the frequencies F7 and F8 is from 0.47 to 11.97 both inclusive.

In order to measure the above-described particle size distribution (volume distribution) of the active material particles, for example, a nanoparticle size distribution measurement apparatus SALD-2100 available from Shimadzu Corporation may be used. In the measurement, for example, one or more of distilled water, ion-exchanged water, etc. may be used as a solvent. Measurement conditions may be set, for example, after dispersing the active material particles in the solvent, as: intensity of ultrasonic wave=7; time of application of ultrasonic wave=5 minutes; and transmittance=from 75% to 90%. However, the measurement conditions such as the intensity of ultrasonic wave may be appropriately changed. When the active material layer 2 is divided into two, and the particle size distributions of the active material particles in the respective layers are examined, for example, part of the active material layer 2 may be peeled off to be removed with the use of Kapton tape, or part of the active material layer 2 may be dissolved to be removed with the use of cotton impregnated with an organic solvent. In this case, in order to precisely know a removed amount, for example, a removed thickness or a remained thickness of the active material layer 2 may be preferably confirmed with the use of a height meter, etc.

[Method of Manufacturing Electrode]

The electrode may be manufactured, for example, by a following procedure.

First, a plurality of active material particles are mixed with other materials such as a binder and an electric conductor, and thereby, an electrode mixture is made. Subsequently, the electrode mixture is dispersed into a solvent such as an organic solvent to make paste-like electrode mixture slurry. Subsequently, the electrode slurry is applied onto both surfaces of the current collector 1 and is dried to form the active material layer 2. At last, the active material layer 2 is compression-molded with the use of a roll press machine, etc. The condition such as pressure at the time of compression process is not particularly limited as long as the pressure allows part of the plurality of active material particles to be crushed. In this case, the active material layer 2 may be compression-molded while being heated, or such compression molding process may be repeated for a plurality of times.

This compression process allows part of the plurality of active material particles to be crushed. Therefore, a particle size of the crushed active material particle is smaller than a particle size of the active material particle before being crushed. Further, the crushing function by the compression process is strongest near the top surface 2X of the active material layer 2 that is directly exposed to the compression process, and is gradually weakened in a direction away from the vicinity of the top surface 2X. Accordingly, the plurality of active material particles are crushed so that the average particle size gradually increases from the top surface 2X toward the bottom surface 2Y in the active material layer 2. Therefore, the distribution of the average particle size of the active material particles has gradient in the thickness direction in which the average particle size of the active material particles reduces gradually in a direction away from the current collector 1. In this case, it is possible to control a state of distribution of the average particle sizes of the active material particles by adjusting conditions such as compression intensity. Thus, the electrode is completed.

[Functions and Effects of Electrode]

According to the above-described electrode, when the active material layer 2 configured of a single layer is divided into two, the average particle size D2 of the active material particles in the upper layer 202 is smaller than the average particle size D1 of the active material particles in the lower layer 201. In this case, as described above, high battery capacity is maintained in cycles and increase in electric resistance is suppressed in cycles. Further, increase in electric resistance resulting from interface resistance is not caused. Therefore, the electric resistance of the electrode as a whole is suppressed to be low. Accordingly, the above-described trade-off relationship is resolved. Therefore, the electric resistance of the electrode as a whole is suppressed to be low, and high battery capacity is achieved. Therefore, superior battery characteristics are achieved.

In particular, in the case where the active material layer 2 configured of a single layer is divided into three, a higher effect is achieved when the average particle size D5 of the active material particles in the upper layer 205 is smaller than the average particle size D3 of the active material particles in the lower layer 203. In this case, a further higher effect is achieved when the average particle size D4 of the active material particles in the intermediate layer 204 is smaller than the average particle size D3 of the active material particles in the lower layer 203 and the average particle size D5 of the active material particles in the upper layer 205 is smaller than the average particle size D4 of the active material particles in the intermediate layer 204.

Moreover, when the distribution of the average particle sizes of the active material particles in the thickness direction has gradient that allows the average particle size of the active material particles to decrease gradually in the direction away from the current collector 1, an extremely high effect is achieved.

Moreover, when the active material layer 2 includes the binder, the above-described conditions related to the average particle size of the active material particles are easily satisfied. Therefore, a higher effect is achieved. Moreover, when the frequency variation ΔF satisfies the above-described conditions, the average particle sizes D1 to D5 are easily controlled with high accuracy. Moreover, a higher effect is achieved, when the above-described first to fifth conditions are satisfied in the case where the active material layer 2 is divided into two, or when the above-described sixth to tenth conditions are satisfied in the case where the active material layer 2 is divided into three.

[2. Secondary Battery]

Next, description will be provided of an application example of the above-described electrode for a secondary battery. The electrode for a secondary battery may be used in a secondary battery as follows, for example.

[2-1. Lithium Ion Secondary Battery (Cylindrical Type)]

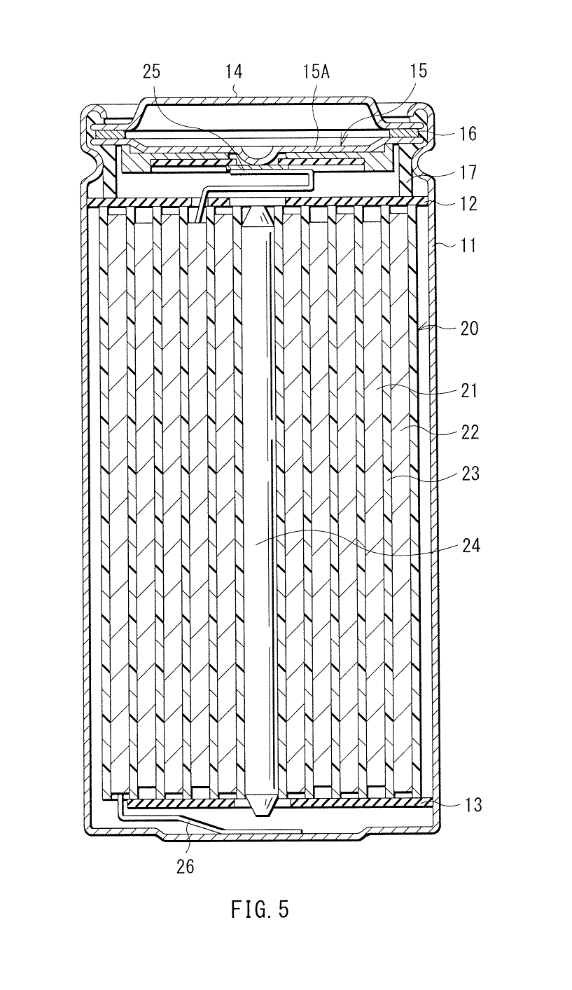

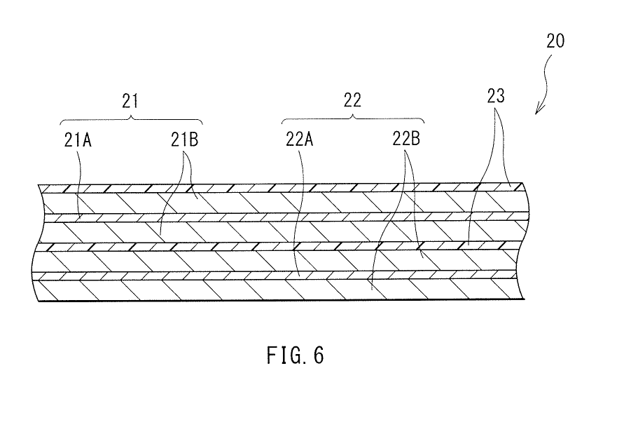

FIGS. 5 and 6 each illustrate a cross-sectional configuration of a secondary battery. FIG. 6 is an enlarged part of a spirally wound electrode body 20 shown in FIG. 5. In this example, the electrode for a secondary battery is applied to a cathode 21, for example.

[General Configuration of Secondary Battery]

The secondary battery described in this example is a lithium secondary battery (lithium ion secondary battery) in which a capacity of an anode 22 is obtained by insertion and extraction of lithium (lithium ions) as an electrode reactant, and has a so-called cylindrical-type battery structure.

For example, the secondary battery may contain a pair of insulating plates 12 and 13 and a spirally wound electrode body 20 inside a battery can 11 in the shape of a substantially-hollow cylinder. In the spirally wound electrode body 20, for example, the cathode 21 and the anode 22 may be layered with a separator 23 in between and may be spirally wound.

For example, the battery can 11 may have a hollow structure in which one end of the battery can 11 is closed and the other end of the battery can 11 is opened. The battery can 11 may be made of, for example, one or more of iron, aluminum, alloys thereof, and the like. The surface of the battery can 11 may be plated with nickel or the like. The pair of insulating plates 12 and 13 is arranged to sandwich the spirally wound electrode body 20 in between, and to extend perpendicularly to the spirally wound periphery surface of the spirally wound electrode body 20.

At the open end of the battery can 11, a battery cover 14, a safety valve mechanism 15, and a positive temperature coefficient device (PTC device) 16 are attached by being swaged with a gasket 17. Thereby, the battery can 11 is hermetically sealed. The battery cover 14 may be made of, for example, a material similar to that of the battery can 11. The safety valve mechanism 15 and the PTC device 16 are provided inside the battery cover 14. The safety valve mechanism 15 is electrically connected to the battery cover 14 through the PTC device 16. In the safety valve mechanism 15, in the case where the internal pressure becomes a certain level or more by internal short circuit, external heating, or the like, a disk plate 15A inverts to cut electric connection between the battery cover 14 and the spirally wound electrode body 20. The PTC device 16 prevents abnormal heat generation resulting from a large current. As temperature rises, resistance of the PTC device 16 is increased accordingly. The gasket 17 may be made of, for example, an insulating material. The surface of the gasket 17 may be coated with asphalt.

In the hollow in the center of the spirally wound electrode body 20, for example, a center pin 24 may be inserted. However, the center pin 24 may not be provided. For example, a cathode lead 25 made of an electrically-conductive material such as aluminum may be connected to the cathode 21. For example, an anode lead 26 made of an electrically-conductive material such as nickel may be connected to the anode 22. For example, the cathode lead 25 may be welded to the safety valve mechanism 15, and may be electrically connected to the battery cover 14. For example, the anode lead 26 may be welded to the battery can 11, and may be electrically connected to the battery can 11.

[Cathode]

The cathode 21 has a configuration similar to that of the above-described electrode for a secondary battery. The cathode 21 includes a cathode current collector 21A and a cathode active material layer 21B on one or both surfaces of the cathode current collector 21A. The configurations of the cathode current collector 21A and the cathode active material layer 21B are similar to the configurations of the current collector 1 and the active material layer 2, respectively.

[Anode]

The anode 22 has an anode active material layer 22B on one or both surfaces of an anode current collector 22A.

The anode current collector 22A may be made of, for example, one or more of electrically-conductive materials such as copper (Cu), nickel, and stainless steel. The surface of the anode current collector 22A may be preferably roughened. Thereby, due to a so-called anchor effect, adhesion characteristics of the anode active material layer 22B with respect to the anode current collector 22A are improved. In this case, it is enough that the surface of the anode current collector 22A in a region opposed to the anode active material layer 22B is roughened at minimum. Examples of roughening methods may include a method of forming fine particles by utilizing electrolytic treatment. The electrolytic treatment is a method of forming the fine particles on the surface of the anode current collector 22A by an electrolytic method in an electrolytic bath to provide concavity and convexity on the surface of the anode current collector 22A. A copper foil fabricated by an electrolytic method is generally called “electrolytic copper foil.”

The anode active material layer 22B contains one or more of anode materials capable of inserting and extracting lithium ions as anode active materials. The anode active material layer 22B may further contain one or more of other materials such as an anode binder and an anode electric conductor. Details of the anode binder and the anode electric conductor may be, for example, similar to those of the cathode binder and the cathode electric conductor. However, the chargeable capacity of the anode material may be preferably larger than the discharge capacity of the cathode 21 in order to prevent lithium metal from being unintentionally precipitated on the anode 22 in the middle of charge. That is, the electrochemical equivalent of the anode material capable of inserting and extracting lithium ions may be preferably larger than the electrochemical equivalent of the cathode 21.

Examples of the anode material may include one or more of carbon materials. In the carbon material, its crystal structure change at the time of insertion and extraction of lithium ions is extremely small, and therefore, the carbon material provides high energy density and superior cycle characteristics. Further, the carbon material serves as an anode electric conductor as well. Examples of the carbon material may include graphitizable carbon, non-graphitizable carbon, and graphite. However, the spacing of (002) plane in the non-graphitizable carbon may be preferably equal to or greater than 0.37 nm, and the spacing of (002) plane in graphite may be preferably equal to or smaller than 0.34 nm. More specifically, examples of the carbon material may include pyrolytic carbons, cokes, glassy carbon fiber, an organic polymer compound fired body, activated carbon, and carbon blacks. Examples of the cokes may include pitch coke, needle coke, and petroleum coke. The organic polymer compound fired body is obtained by firing (carbonizing) a polymer compound such as a phenol resin and a furan resin at appropriate temperature. In addition thereto, the carbon material may be low crystalline carbon or amorphous carbon heat-treated at temperature of about 1000° C. or lower. It is to be noted that the shape of the carbon material may be any of a fibrous shape, a spherical shape, a granular shape, and a scale-like shape.

Further, the anode material may be, for example, a material (metal-based material) containing one or more of metal elements and metalloid elements as constitutional elements, since higher energy density is thereby obtained. Such a metal-based material may be a simple substance, an alloy, or a compound, may be two or more thereof, or may have one or more phases thereof in part or all thereof. “Alloy” includes a material containing one or more metal elements and one or more metalloid elements, in addition to a material configured of two or more metal elements. Further, the “alloy” may contain a nonmetallic element. Examples of the structure thereof may include a solid solution, a eutectic crystal (eutectic mixture), an intermetallic compound, and a structure in which two or more thereof coexist.

Examples of the foregoing metal elements and the foregoing metalloid elements may include one or more of metal elements and metalloid elements capable of forming an alloy with lithium. Specific examples thereof may include Mg, B, Al, Ga, In, Si, Ge, Sn, Pb, Bi, Cd, Ag, Zn, Hf, Zr, Y, Pd, and Pt. In particular, Si, Sn, or both may be preferable. One reason for this is that Si and Sn have a superior ability of inserting and extracting lithium ions, and therefore, provide high energy density.

A material containing Si, Sn, or both as constituent elements may be any of a simple substance, an alloy, and a compound of Si, may be any of a simple substance, an alloy, and a compound of Sn, may be two or more thereof, or may have one or more phases thereof in part or all thereof. It is to be noted that “simple substance” merely refers to a general simple substance (a small amount of impurity may be therein contained), and does not necessarily refer to a purity 100% simple substance.

The alloys of Si may contain, for example, one or more of elements such as Sn, Ni, Cu, Fe, Co, Mn, Zn, In, Ag, Ti, Ge, Bi, Sb, and Cr as constituent elements other than Si. The compounds of Si may contain, for example, one or more of C, O, and the like as constituent elements other than Si. It is to be noted that, for example, the compounds of Si may contain one or more of the elements described for the alloys of Si as constituent elements other than Si.

Examples of the alloys of Si and the compounds of Si may include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v<2), and LiSiO. v in SiOᵥ may be in the range of 0.2<v<1.4.

The alloys of Sn may contain, for example, one or more of elements such as Si, Ni, Cu, Fe, Co, Mn, Zn, In, Ag, Ti, Ge, Bi, Sb, and Cr as constituent elements other than Sn. The compounds of Sn may contain, for example, one or more of elements such as C and O as constituent elements other than Sn. It is to be noted that the compounds of Sn may contain, for example, one or more of elements described for the alloys of Sn as constituent elements other than Sn. Examples of the alloys of Sn and the compounds of Sn may include SnO_{w} (0<w<2), SnSiO₃, LiSnO, and Mg₂Sn.

Further, as a material containing Sn as a constituent element, for example, a material containing a second constituent element and a third constituent element in addition to Sn as a first constituent element may be preferable. Examples of the second constituent element may include one or more of elements such as Co, Fe, Mg, Ti, V, Cr, Mn, Ni, Cu, Zn, Ga, Zr, Nb, Mo, Ag, In, Ce, Hf, Ta, W, Bi, and Si. Examples of the third constituent element may include one or more of elements such as B, C, Al, and P. In the case where the second constituent element and the third constituent element are contained, a high battery capacity, superior cycle characteristics, and the like are obtained.

In particular, a material (SnCoC-containing material) containing Sn, Co, and C as constituent elements may be preferable. The composition of the SnCoC-containing material may be, for example, as follows. That is, the C content may be from 9.9 mass % to 29.7 mass % both inclusive, and the ratio of Sn and Co contents (Co/(Sn+Co)) may be from 20 mass % to 70 mass % both inclusive, since high energy density is obtained in such a composition range.

It may be preferable that the SnCoC-containing material have a phase containing Sn, Co, and C. Such a phase may be preferably low-crystalline or amorphous. The phase is a reaction phase capable of reacting with lithium. Due to existence of the reaction phase, superior characteristics are obtained. The half bandwidth of the diffraction peak obtained by an XRD method of the phase may be preferably equal to or greater than 1 deg based on diffraction angle of 2θ in the case where CuKα ray is used as a specific X ray, and the insertion rate is 1 deg/min. Thereby, lithium is more smoothly inserted and extracted, and reactivity with the electrolytic solution is decreased. It is to be noted that, in some cases, the SnCoC-containing material includes a phase containing a simple substance or part of the respective constituent elements in addition to the low-crystalline phase or the amorphous phase.

Whether or not the diffraction peak obtained by the X-ray diffraction corresponds to the reaction phase capable of reacting with lithium is allowed to be easily determined by comparison between X-ray diffraction charts before and after electrochemical reaction with lithium. For example, if the position of the diffraction peak after electrochemical reaction with lithium is changed from the position of the diffraction peak before the electrochemical reaction with lithium, the obtained diffraction peak corresponds to the reaction phase capable of reacting with lithium. In this case, for example, the diffraction peak of the low crystalline reaction phase or the amorphous reaction phase is seen in the range of 2θ=from 20 deg to 50 deg both inclusive. Such a reaction phase may have, for example, the foregoing respective constituent elements, and the low crystalline or amorphous structure thereof possibly results from existence of C mainly.

In the SnCoC-containing material, part or all of C as a constituent element may be preferably bonded to a metal element or a metalloid element as other constituent element, since cohesion or crystallization of Sn and/or the like is suppressed thereby. The bonding state of elements is allowed to be checked by, for example, an X-ray photoelectron spectroscopy method (XPS). In a commercially-available device, for example, as a soft X ray, Al—Kα ray, Mg—Kα ray, or the like may be used. In the case where part or all of C are bonded to a metal element, a metalloid element, or the like, the peak of a synthetic wave of 1s orbit of C(C1s) is shown in a region lower than 284.5 eV. It is to be noted that, in the device, energy calibration is made so that the peak of 4f orbit of Au atom (Au4f) is obtained in 84.0 eV. At this time, in general, since surface contamination carbon exists on the material surface, the peak of C1s of the surface contamination carbon is regarded as 284.8 eV, which is used as the energy standard. In XPS measurement, the waveform of the peak of C1s is obtained as a form including the peak of the surface contamination carbon and the peak of carbon in the SnCoC-containing material. Therefore, for example, analysis may be made with the use of commercially-available software to isolate both peaks from each other. In the waveform analysis, the position of the main peak existing on the lowest bound energy side is the energy standard (284.8 eV).

It is to be noted that the SnCoC-containing material is not limited to the material (SnCoC) configured of only Sn, Co, and C as constituent elements. That is, the SnCoC-containing material may further contain, for example, one or more of Si, Fe, Ni, Cr, In, Nb, Ge, Ti, Mo, Al, P, Ga, Bi, and the like as constituent elements, in addition to Sn, Co, and C.

In addition to the SnCoC-containing material, a material containing Sn, Co, Fe, and C as constituent elements (SnCoFeC-containing material) may be also preferable. The composition of the SnCoFeC-containing material may be any composition. For example, the composition in which the Fe content is set small may be as follows. That is, the C content may be from 9.9 mass % to 29.7 mass % both inclusive, the Fe content may be from 0.3 mass % to 5.9 mass % both inclusive, and the ratio of contents of Sn and Co (Co/(Sn+Co)) may be from 30 mass % to 70 mass % both inclusive. Further, the composition in which the Fe content is set large is as follows. That is, the C content is from 11.9 mass % to 29.7 mass % both inclusive, the ratio of contents of Sn, Co, and Fe ((Co+Fe)/(Sn+Co+Fe)) is from 26.4 mass % to 48.5 mass % both inclusive, and the ratio of contents of Co and Fe (Co/(Co+Fe)) is from 9.9 mass % to 79.5 mass % both inclusive. In such a composition range, high energy density is obtained. The physical properties (such as half bandwidth) of the SnCoFeC-containing material are similar to those of the foregoing SnCoC-containing material.

In addition thereto, the anode material may be, for example, one or more of a metal oxide, a polymer compound, and the like. Examples of the metal oxide may include iron oxide, ruthenium oxide, and molybdenum oxide. Examples of the polymer compound may include polyacetylene, polyaniline, and polypyrrole.

The anode active material layer 22B may be formed by, for example, one or more of a coating method, a vapor-phase deposition method, a liquid-phase deposition method, a spraying method, and a firing method (sintering method). The coating method may be a method in which, for example, after a particulate (powder) anode active material is mixed with an anode binder and/or the like, the mixture is dispersed in a solvent such as an organic solvent, and the anode current collector 22A is coated with the resultant. Examples of the vapor-phase deposition method may include a physical deposition method and a chemical deposition method. More specifically, examples thereof may include a vacuum evaporation method, a sputtering method, an ion plating method, a laser ablation method, a thermal chemical vapor deposition method, a chemical vapor deposition (CVD) method, and a plasma chemical vapor deposition method. Examples of the liquid-phase deposition method may include an electrolytic plating method and an electroless plating method. The spraying method is a method in which an anode active material in a fused state or a semi-fused state is sprayed to the anode current collector 22A. The firing method may be, for example, a method in which after the anode current collector 22A is coated with the mixture dispersed in the solvent by a coating method, heat treatment is performed at temperature higher than the melting point of the anode binder and/or the like. Examples of the firing method may include an atmosphere firing method, a reactive firing method, and a hot press firing method.

In the secondary battery, as described above, in order to prevent lithium metal from being unintentionally precipitated on the anode 22 in the middle of charge, the electrochemical equivalent of the anode material capable of inserting and extracting lithium ion may be preferably larger than the electrochemical equivalent of the cathode. Further, in the case where the open circuit voltage (that is, a battery voltage) at the time of completely-charged state is equal to or greater than 4.25 V, the extraction amount of lithium ions per unit mass is larger than that in the case where the open circuit voltage is 4.20 V even if the same cathode active material is used. Therefore, amounts of the cathode active material and the anode active material are adjusted accordingly. Thereby, high energy density is obtainable.

[Separator]

The separator 23 separates the cathode 21 from the anode 22, and passes lithium ions while preventing current short circuit resulting from contact of both electrodes. The separator 23 may be, for example, a porous film made of a synthetic resin, ceramics, or the like. The separator 23 may be a laminated film in which two or more types of porous films are laminated. Examples of the synthetic resin may include polytetrafluoroethylene, polypropylene, and polyethylene.

In particular, the separator 23 may include, for example, a polymer compound layer provided on one surface or both surfaces of the foregoing porous film (base material layer). One reason for this is that, thereby, adhesion characteristics of the separator 23 with respect to the cathode 21 and the anode 22 are improved, and therefore, skewness of the spirally wound electrode body 20 is suppressed. Thereby, a decomposition reaction of the electrolytic solution is suppressed, and liquid leakage of the electrolytic solution with which the base material layer is impregnated is suppressed. Accordingly, even if charge and discharge are repeated, the resistance is less likely to be increased, and battery swollenness is suppressed.

The polymer compound layer may contain, for example, a polymer material such as polyvinylidene fluoride, since such a polymer material has superior physical strength and is electrochemically stable. However, the polymer material may be a polymer material other than polyvinylidene fluoride. The polymer compound layer may be formed as follows when such a polymer compound layer is formed, for example. That is, after a solution in which the polymer material is dissolved is prepared, the base material layer is coated with the solution, and the resultant is subsequently dried. Alternatively, the base material layer may be soaked in the solution and may be subsequently dried.

[Electrolytic Solution]

The separator 23 is impregnated with an electrolytic solution as a liquid electrolyte. The electrolytic solution contains a solvent and an electrolyte salt, and may further contain one or more of other materials such as an additive.

The solvent contains one or more of nonaqueous solvents such as an organic solvent. Examples of the nonaqueous solvents may include a cyclic ester carbonate, a chain ester carbonate, lactone, a chain carboxylic ester, and nitrile, since a superior battery capacity, superior cycle characteristics, superior conservation characteristics, and the like are thereby obtained. Examples of the cyclic ester carbonate may include ethylene carbonate, propylene carbonate, and butylene carbonate. Examples of the chain ester carbonate may include dimethyl carbonate, diethyl carbonate, ethyl methyl carbonate, and methylpropyl carbonate. Examples of the lactone may include γ-butyrolactone and γ-valerolactone. Examples of the carboxylic ester may include methyl acetate, ethyl acetate, methyl propionate, ethyl propionate, methyl butyrate, methyl isobutyrate, methyl trimethylacetate, and ethyl trimethylacetate. Examples of the nitrile may include acetonitrile, glutaronitrile, adiponitrile, methoxyacetonitrile, and 3-methoxypropionitrile.

In addition thereto, the nonaqueous solvent may be, for example, 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, N,N-dimethylformamide, N-methylpyrrolidinone, N-methyloxazolidinone, N,N′-dimethylimidazolidinone, nitro methane, nitroethane, sulfolane, trimethyl phosphate, or dimethyl sulfoxide, since thereby, a similar advantage is obtained.

In particular, one or more of ethylene carbonate, propylene carbonate, dimethyl carbonate, diethyl carbonate, and ethyl methyl carbonate may be preferable, since a further superior battery capacity, further superior cycle characteristics, further superior conservation characteristics, and the like are thereby obtained. In this case, a combination of a high viscosity (high dielectric constant) solvent (for example, specific dielectric constant ∈≧30) such as ethylene carbonate and propylene carbonate and a low viscosity solvent (for example, viscosity≦1 mPa·s) such as dimethyl carbonate, ethylmethyl carbonate, and diethyl carbonate may be more preferable. One reason for this is that the dissociation property of the electrolyte salt and ion mobility are thereby improved.

In particular, the solvent may contain one or more of an unsaturated cyclic ester carbonate, a halogenated ester carbonate, sultone (cyclic sulfonic ester), an acid anhydride, and the like. One reason for this is that, in this case, chemical stability of the electrolytic solution is improved. The unsaturated cyclic ester carbonate is a cyclic ester carbonate including one or more unsaturated carbon bonds (carbon-carbon double bonds). Examples of the unsaturated cyclic ester carbonate may include vinylene carbonate, vinylethylene carbonate, and methyleneethylene carbonate. The halogenated ester carbonate is a cyclic ester carbonate having one or more halogens as constituent elements or a chain ester carbonate having one or more halogens as constituent elements. Examples of the cyclic halogenated ester carbonate may include 4-fluoro-1,3-dioxolane-2-one and 4,5-difluoro-1,3-dioxolane-2-one. Examples of the chain halogenated ester carbonate may include fluoromethyl methyl carbonate, bis (fluoromethyl) carbonate, and difluoromethyl methyl carbonate. Examples of the sultone may include propane sultone and propene sultone. Examples of the acid anhydrides may include a succinic anhydride, an ethane disulfonic anhydride, and a sulfobenzoic anhydride. However, the solvent is not limited to the foregoing material, and may be other material.

The electrolyte salt may contain, for example, one or more of salts such as a lithium salt. However, the electrolyte salt may contain a salt other than the lithium salt. Examples of the salt other than the lithium salt may include a light metal salt other than the lithium salt.

Examples of the lithium salts may include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethane sulfonate (LiCF₃SO₃), lithium tetrachloroaluminate (LiAlCl₄), dilithium hexafluorosilicate (Li₂SiF₆), lithium chloride (LiCl), and lithium bromide (LiBr). Thereby, a superior battery capacity, superior cycle characteristics, superior conservation characteristics, and the like are obtained.

In particular, one or more of LiPF₆, LiBF₄, LiClO₄, and LiAsF₆ may be preferable, and LiPF₆ may be more preferable, since the internal resistance is thereby lowered, and therefore, a higher effect is obtained. However, the electrolyte salt is not limited to the foregoing materials, and may be other material.

Although the content of the electrolyte salt is not particularly limited, the content thereof may be preferably from 0.3 mol/kg to 3.0 mol/kg both inclusive with respect to the solvent, since high ion conductivity is obtained thereby.

[Operation of Secondary Battery]

The secondary battery may operate, for example, as follows. At the time of charge, lithium ions extracted from the cathode 21 may be inserted in the anode 22 through the electrolytic solution. In contrast, at the time of discharge, lithium ions extracted from the anode 22 may be inserted in the cathode 21 through the electrolytic solution.

[Method of Manufacturing Secondary Battery]

The secondary battery may be manufactured, for example, by the following procedure.

First, the cathode 21 is fabricated by a fabrication procedure similar to that of the electrode for the secondary battery described above. Specifically, the cathode active material layers 21B are formed on both surfaces of the cathode current collector 21A, and thereby, the cathode 21 is fabricated.

Further, the anode 22 is fabricated by a procedure similar to that of the cathode 21 described above. Specifically, the anode active material is mixed with the anode binder, the anode electric conductor, and/or the like to prepare an anode mixture, which is subsequently dispersed in a solvent such as an organic solvent to form paste-like anode mixture slurry. Subsequently, both surfaces of the anode current collector 22A are coated with the anode mixture slurry, which is dried to form the anode active material layer 22B. Thereafter, the anode active material layer 22B is compression-molded.

Finally, the secondary battery is assembled using the cathode 21 and the anode 22. The cathode lead 25 is attached to the cathode current collector 21A by a welding method and/or the like, and the anode lead 26 is attached to the anode current collector 22A by a welding method and/or the like. Subsequently, the cathode 21 and the anode 22 are layered with the separator 23 in between and are spirally wound, and the spirally wound electrode body 20 is thereby fabricated. Thereafter, the center pin 24 is inserted in the center of the spirally wound electrode body. Subsequently, the spirally wound electrode body 20 is sandwiched between the pair of insulating plates 12 and 13, and is contained in the battery can 11. In this case, the end tip of the cathode lead 25 is attached to the safety valve mechanism 15 by a welding method and/or the like, and the end tip of the anode lead 26 is attached to the battery can 11 by a welding method and/or the like. Subsequently, the electrolytic solution in which the electrolyte salt is dispersed in the solvent is injected into the battery can 11, and the separator 23 is impregnated with the electrolytic solution. Subsequently, at the open end of the battery can 11, the battery cover 14, the safety valve mechanism 15, and the PTC device 16 are fixed by being swaged with the gasket 17.

[Function and Effect of Secondary Battery]

According to the above-described secondary battery of the cylindrical type, the cathode 21 has a configuration similar to the configuration of the above-described electrode for a secondary battery. Therefore, high battery capacity is achieved while the electric resistance of the cathode 21 as a whole is suppressed to be low. Therefore, superior battery characteristics are achievable. Functions and effects other than this are similar to those of the electrode for the secondary battery.

[2-2. Lithium Ion Secondary Battery (Laminated Film Type)]

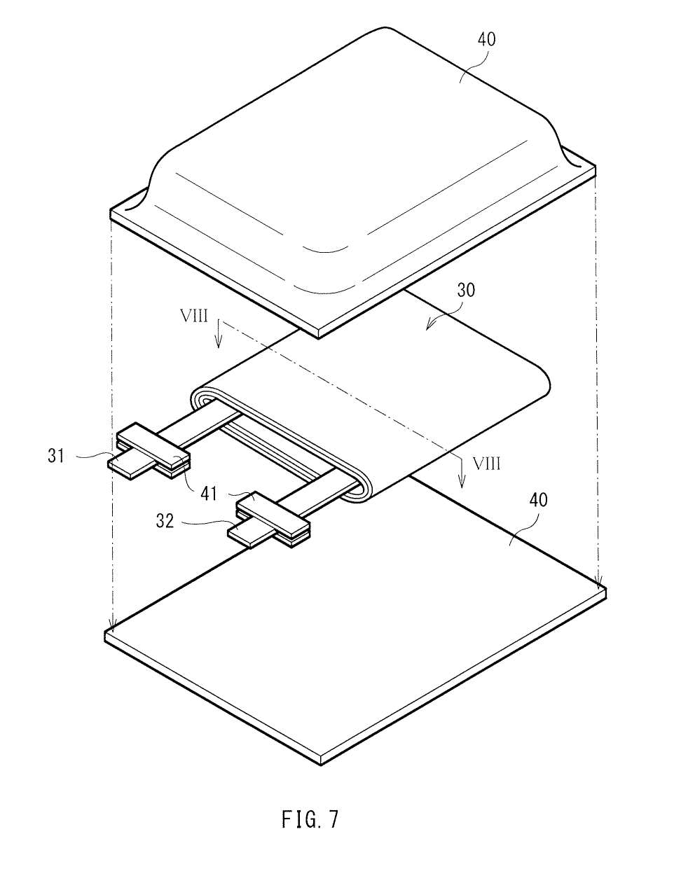

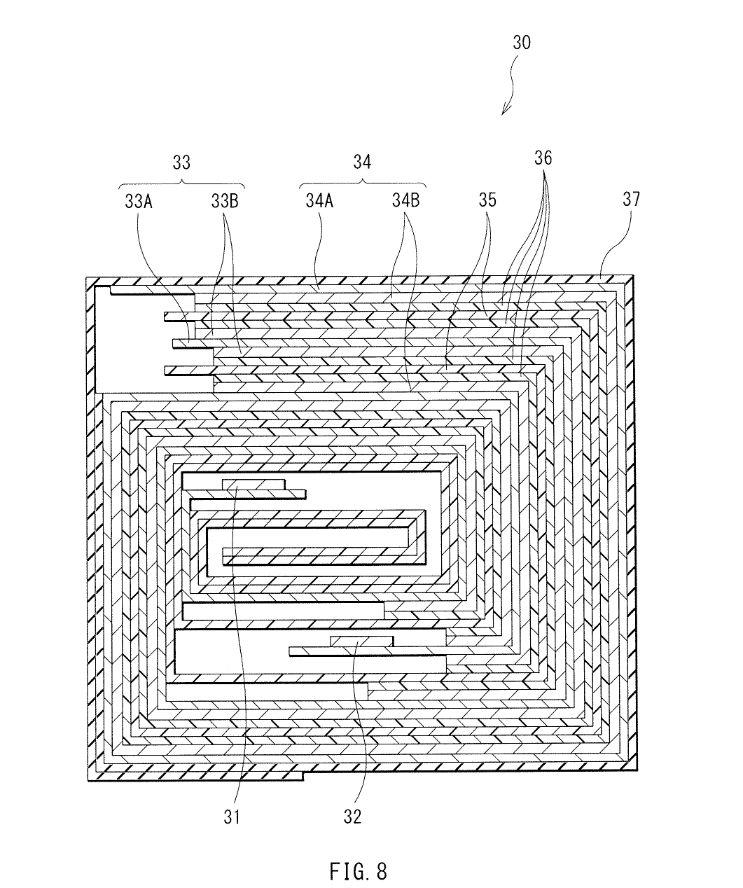

FIG. 7 illustrates a perspective configuration of another secondary battery. FIG. 8 illustrates an enlarged cross-section taken along a line VIII-VIII of a spirally wound electrode body 30 illustrated in FIG. 7. However, FIG. 7 illustrates a state that the spirally wound electrode body 30 is separated from two outer package members 40. In the following description, the elements of the cylindrical-type secondary battery described above will be used as necessary.

[General Configuration of Secondary Battery]

The secondary battery described here is a so-called laminated-film-type lithium ion secondary battery. For example, the spirally wound electrode body 30 may be contained in a film-like outer package member 40. In the spirally wound electrode body 30, a cathode 33 and the anode 34 are layered with a separator 35 and an electrolyte layer 36 in between and are spirally wound. A cathode lead 31 is attached to the cathode 33, and an anode lead 32 is attached to the anode 34. The outermost periphery of the spirally wound electrode body 30 is protected by a protective tape 37.

The cathode lead 31 and the anode lead 32 may be, for example, led out from inside to outside of the outer package member 40 in the same direction. The cathode lead 31 may be made one or more of electrically-conductive materials such as aluminum, and the anode lead 32 may be made one or more of electrically-conducive materials such as copper, nickel, and stainless steel. These electrically-conductive materials may be in the shape of, for example, a thin plate or mesh.

The outer package member 40 may be a laminated film in which, for example, a fusion bonding layer, a metal layer, and a surface protective layer are laminated in this order. The outer package member 40 may be obtained by, for example, layering two laminated films so that the fusion bonding layers are opposed to the spirally wound electrode body 30, and subsequently fusion bonding outer edges of the respective fusion bonding layers. However, the two laminated films may be bonded to each other by an adhesive, or the like. Examples of the fusion bonding layer may include a film made of polyethylene, polypropylene, or the like. Examples of the metal layer may include an aluminum foil. Examples of the surface protective layer may include a film made of nylon, polyethylene terephthalate, or the like.

In particular, the outer package member 40 may preferably be an aluminum laminated film in which a polyethylene film, an aluminum foil, and a nylon film are laminated in this order. However, the outer package member 40 may be a laminated film having other laminated structure, a polymer film such as polypropylene, or a metal film.

For example, an adhesive film 41 to prevent outside air intrusion may be inserted between the outer package member 40 and the cathode lead 31 and between the outer package member 40 and the anode lead 32. The adhesive film 41 is made of a material having adhesion characteristics with respect to the cathode lead 31 and the anode lead 32. Examples of the material having adhesion characteristics may include a polyolefin resin. More specific examples thereof may include polyethylene, polypropylene, modified polyethylene, and modified polypropylene.

The cathode 33 may have, for example, a cathode active material layer 33B on one or both surfaces of a cathode current collector 33A. The anode 34 may have, for example, an anode active material layer 34B on one or both surfaces of an anode current collector 34A. The configurations of the cathode current collector 33A, the cathode active material layer 33B, the anode current collector 34A, and the anode active material layer 34B are similar to the configurations of the cathode current collector 21A, the cathode active material layer 21B, the anode current collector 22A, and the anode active material layer 22B, respectively. That is, the cathode 33 has a configuration similar to the configuration of the electrode for a secondary battery. A configuration of the separator 35 is similar to the configuration of the separator 23.

[Electrolyte Layer]

In the electrolyte layer 36, an electrolytic solution is held by a polymer compound. The electrolyte layer 36 is a so-called gel electrolyte, since thereby, high ion conductivity (for example, 1 mS/cm or more at room temperature) is obtained and liquid leakage of the electrolytic solution is prevented. The electrolyte layer 36 may further contain other material such as an additive.

The polymer compound contains one or more of polymer materials. Examples of the polymer materials may include polyacrylonitrile, polyvinylidene fluoride, polytetrafluoroethylene, polyhexafluoropropylene, polyethylene oxide, polypropylene oxide, polyphosphazene, polysiloxane, polyvinyl fluoride, polyvinyl acetate, polyvinyl alcohol, polymethacrylic acid methyl, polyacrylic acid, polymethacrylic acid, styrene-butadiene rubber, nitrile-butadiene rubber, polystyrene, and polycarbonate. In addition thereto, the polymer material may be a copolymer. The copolymer may be, for example, a copolymer of vinylidene fluoride and hexafluoro propylene. In particular, polyvinylidene fluoride or the copolymer of vinylidene fluoride and hexafluoro propylene may be preferable, and polyvinylidene fluoride may be more preferable, since such a polymer compound is electrochemically stable.

For example, the composition of the electrolytic solution may be similar to the composition of the electrolytic solution of the cylindrical-type secondary battery. However, in the electrolyte layer 36 as a gel electrolyte, the solvent of the electrolytic solution refers to a wide concept including not only a liquid solvent but also a material having ion conductivity capable of dissociating the electrolyte salt. Therefore, in the case where a polymer compound having ion conductivity is used, the polymer compound is also included in the solvent.

It is to be noted that the electrolytic solution may be used as it is instead of the gel electrolyte layer 36. In this case, the separator 35 is impregnated with the electrolytic solution.

[Operation of Secondary Battery]

The secondary battery may operate, for example, as follows. At the time of charge, lithium ions extracted from the cathode 33 may be inserted in the anode 34 through the electrolyte layer 36. In contrast, at the time of discharge, lithium ions extracted from the anode 34 may be inserted in the cathode 33 through the electrolyte layer 36.

[Method of Manufacturing Secondary Battery]

The secondary battery including the gel electrolyte layer 36 may be manufactured, for example, by the following three types of procedures.

In the first procedure, the cathode 33 and the anode 34 are fabricated by a fabrication procedure similar to that of the cathode 21 and the anode 22. In this case, the cathode 33 is fabricated by forming the cathode active material layer 33B on both surfaces of the cathode current collector 33A, and the anode 34 is fabricated by forming the anode active material layer 34B on both surfaces of the anode current collector 34A. Subsequently, a precursor solution containing an electrolytic solution, a polymer compound, and a solvent such as an organic solvent is prepared. Thereafter, the cathode 33 and the anode 34 are coated with the precursor solution to form the gel electrolyte layer 36. Subsequently, the cathode lead 31 is attached to the cathode current collector 33A by a welding method and/or the like, and the anode lead 32 is attached to the anode current collector 34A by a welding method and/or the like. Subsequently, the cathode 33 and the anode 34 are layered with the separator 35 in between and are spirally wound to fabricate the spirally wound electrode body 30. Thereafter, the protective tape 37 is adhered to the outermost periphery thereof. Subsequently, after the spirally wound electrode body 30 is sandwiched between two pieces of film-like outer package members 40, the outer edges of the outer package members 40 are bonded by a thermal fusion bonding method and/or the like to enclose the spirally wound electrode body 30 into the outer package members 40. In this case, the adhesive films 41 are inserted between the cathode lead 31 and the outer package member 40 and between the anode lead 32 and the outer package member 40.

In the second procedure, the cathode lead 31 is attached to the cathode 33, and the anode lead 32 is attached to the anode 34. Subsequently, the cathode 33 and the anode 34 are layered with the separator 35 in between and are spirally wound to fabricate a spirally wound body as a precursor of the spirally wound electrode body 30. Thereafter, the protective tape 37 is adhered to the outermost periphery thereof. Subsequently, after the spirally wound body is sandwiched between two pieces of the film-like outer package members 40, the outermost peripheries except for one side are bonded by a thermal fusion bonding method and/or the like, and the spirally wound body is contained in the pouch-like outer package member 40. Subsequently, an electrolytic solution, a monomer as a raw material for the polymer compound, a polymerization initiator, and other materials such as a polymerization inhibitor are mixed to prepare a composition for electrolyte. Subsequently, the composition for electrolyte is injected into the pouch-like outer package member 40. Thereafter, the outer package member 40 is hermetically sealed by a thermal fusion bonding method and/or the like. Subsequently, the monomer is thermally polymerized, and thereby, a polymer compound is formed. Thereby, the polymer compound is impregnated with the electrolytic solution, the polymer compound is gelated, and accordingly, the electrolyte layer 36 is formed.

In the third procedure, the spirally wound body is fabricated and contained in the pouch-like outer package member 40 in a manner similar to that of the foregoing second procedure, except that the separator 35 with both surfaces coated with a polymer compound is used. Examples of the polymer compound with which the separator 35 is coated may include a polymer (a homopolymer, a copolymer, or a multicomponent copolymer) containing vinylidene fluoride as a component. Specific examples of the homopolymer may include polyvinylidene fluoride. Examples of the copolymer may include a binary copolymer containing vinylidene fluoride and hexafluoro propylene as components. Examples of the multicomponent copolymer may include a ternary copolymer containing vinylidene fluoride, hexafluoro propylene, and chlorotrifluoroethylene as components. It is to be noted that, in addition to the polymer containing vinylidene fluoride as a component, other one or more polymer compounds may be used. Subsequently, an electrolytic solution is prepared and injected into the outer package member 40. Thereafter, the opening of the outer package member 40 is hermetically sealed by a thermal fusion bonding method and/or the like. Subsequently, the resultant is heated while a weight is applied to the outer package member 40, and the separator 35 is adhered to the cathode 33 and the anode 34 with the polymer compound in between. Thereby, the polymer compound is impregnated with the electrolytic solution, the polymer compound is gelated, and accordingly, the electrolyte layer 36 is formed.

In the third procedure, swollenness of the secondary battery is suppressed more than in the first procedure. Further, in the third procedure, the monomer as a raw material of the polymer compound, the solvent, and the like are less likely to be left in the electrolyte layer 36 compared to in the second procedure. Therefore, the formation step of the polymer compound is favorably controlled. Therefore, sufficient adhesion characteristics are obtained between the cathode 33, the anode 34, and the separator 35, and the electrolyte layer 36.

[Function and Effect of Secondary Battery]

According to the laminated-film-type secondary battery, the cathode 33 has a configuration similar to the configuration of the electrode for a secondary battery. Therefore, superior battery characteristics are achievable for a reason similar to that of the cylindrical-type secondary battery. Other functions and other effects are similar to those of the cylindrical-type secondary battery.

[2-3. Lithium Metal Secondary Battery]

A secondary battery described herein is a lithium secondary battery (a lithium metal secondary battery) in which the capacity of the anode 22 is represented by precipitation and dissolution of lithium metal. This secondary battery has a configuration similar to the configuration of the lithium ion secondary battery (of the cylindrical type) described above and is manufactured by a procedure similar to the procedure of manufacturing the lithium ion secondary battery (of the cylindrical type) described above except that the anode active material layer 22B is formed of lithium metal.

In this secondary battery, lithium metal is used as the anode active material. Therefore, high energy density is achievable. The anode active material layer 22B may be already present at the time of assembling. Alternatively, the anode active material layer 22B may not be present at the time of assembling, and may be formed of lithium metal that is precipitated at the time of charging. Alternatively, the anode current collector 22A may be omitted by utilizing the anode active material layer 22B as a current collector.

This secondary battery may operate as follows, for example. At the time of charging, when lithium ions are emitted from the cathode 21, the emitted lithium ions are precipitated as lithium metal on a surface of the anode current collector 22A through the electrolytic solution. On the other hand, at the time of discharging, when lithium metal is dissolved as lithium ions from the anode active material layer 22B into the electrolytic solution, the dissolved lithium ions are inserted in the cathode 21 through the electrolytic solution.

According to this lithium metal secondary battery, the cathode 21 has a configuration similar to the configuration of the electrode for a secondary battery. Therefore, superior battery characteristics are achievable based on reasons similar to that of the lithium ion secondary battery described above. Functions and effects other than this are similar to those in the case of the lithium ion secondary battery. It is to be noted that the lithium metal secondary battery described here is not limited to a cylindrical type, and may be of a laminated film type. A similar effect is achievable also in such a case.

[3. Applications of Secondary Battery]

Next, a description will be given of application examples of the foregoing secondary batteries.

Applications of the secondary battery are not particularly limited as long as the secondary battery is applied to a machine, a device, an instrument, an apparatus, a system (collective entity of a plurality of devices and the like), or the like that is allowed to use the secondary battery as a driving electric power source, an electric power storage source for electric power storage, or the like. The secondary battery used as an electric power source may be a main electric power source (electric power source used preferentially), or may be an auxiliary electric power source (electric power source used instead of a main electric power source or used being switched from the main electric power source). In the case where the secondary battery is used as an auxiliary electric power source, the main electric power source type is not limited to the secondary battery.

Examples of applications of the secondary battery may include electronic apparatuses (including portable electronic apparatuses) such as a video camcorder, a digital still camera, a mobile phone, a notebook personal computer, a cordless phone, a headphone stereo, a portable radio, a portable television, and a personal digital assistant. Further examples thereof may include a mobile lifestyle electric appliance such as an electric shaver; a storage device such as a backup electric power source and a memory card; an electric power tool such as an electric drill and an electric saw; a battery pack used as a attachable and detachable electric power source of a notebook personal computer or the like; a medical electronic apparatus such as a pacemaker and a hearing aid; an electric vehicle such as an electric automobile (including a hybrid automobile); and an electric power storage system such as a home battery system for storing electric power for emergency or the like. It goes without saying that an application other than the foregoing applications may be adopted.

In particular, the secondary battery is effectively applicable to the battery pack, the electric vehicle, the electric power storage system, the electric power tool, the electronic apparatus, or the like. One reason for this is that, in these applications, since superior battery characteristics are demanded, performance is effectively improved with the use of the secondary battery according to the embodiment of the present application. It is to be noted that the battery pack is an electric power source using a secondary battery, and is a so-called assembled battery or the like. The electric vehicle is a vehicle that works (runs) with the use of a secondary battery as a driving electric power source. As described above, the electric vehicle may be an automobile (such as a hybrid automobile) including a drive source other than a secondary battery. The electric power storage system is a system using a secondary battery as an electric power storage source. For example, in a home electric power storage system, electric power is stored in the secondary battery as an electric power storage source, and therefore, home electric products and the like become usable with the use of the electric power. The electric power tool is a tool in which a movable section (such as a drill) is moved with the use of a secondary battery as a driving electric power source. The electronic apparatus is an apparatus executing various functions with the use of a secondary battery as a driving electric power source (electric power supply source).

A description will be specifically given of some application examples of the secondary battery. It is to be noted that the configurations of the respective application examples explained below are merely examples, and may be changed as appropriate.

[3-1. Battery Pack]

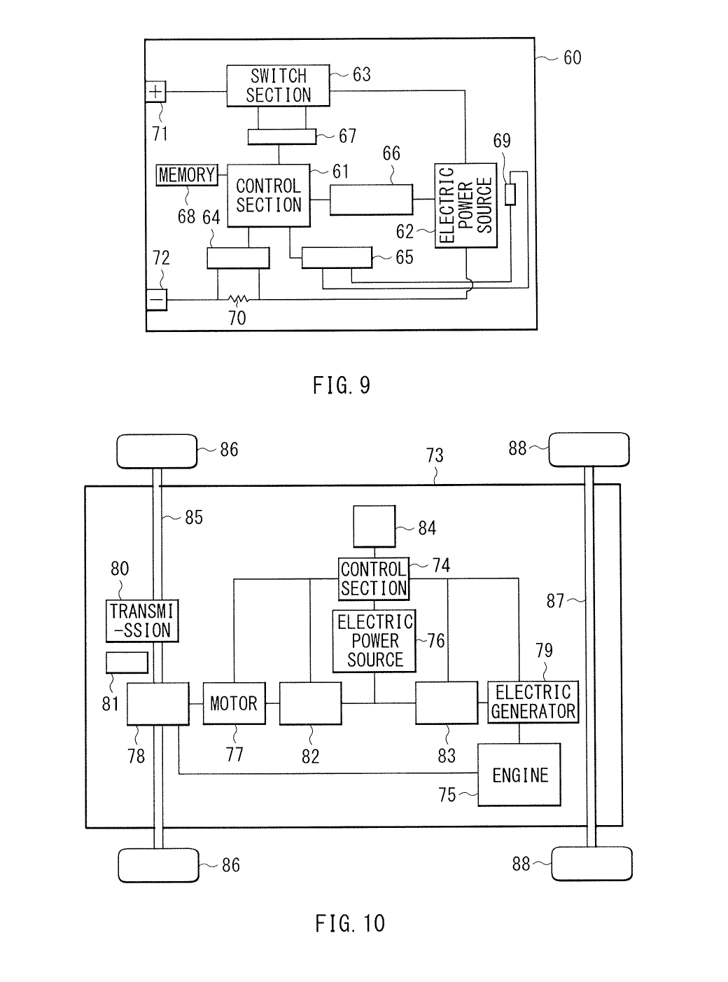

FIG. 9 illustrates a block configuration of a battery pack. For example, the battery pack may include a control section 61, an electric power source 62, a switch section 63, a current measurement section 64, a temperature detection section 65, a voltage detection section 66, a switch control section 67, a memory 68, a temperature detection device 69, a current detection resistance 70, a cathode terminal 71, and an anode terminal 72 in a housing 60. The housing 60 may be made of, for example, a plastic material and/or the like.

The control section 61 controls operation of the whole battery pack (including a used state of the electric power source 62), and may include, for example, a central processing unit (CPU) and/or the like. The electric power source 62 includes one or more secondary batteries (not illustrated). The electric power source 62 may be, for example, an assembled battery including two or more secondary batteries. Connection type of the secondary batteries may be a series-connected type, may be a parallel-connected type, or may be a mixed type thereof. As an example, the electric power source 62 may include six secondary batteries connected in a manner of dual-parallel and three-series.

The switch section 63 switches the used state of the electric power source 62 (whether or not the electric power source 62 is connectable to an external device) according to an instruction of the control section 61. The switch section 63 may include, for example, a charge control switch, a discharge control switch, a charging diode, a discharging diode, and the like (not illustrated). The charge control switch and the discharge control switch may each be, for example, a semiconductor switch such as a field-effect transistor (MOSFET) using a metal oxide semiconductor.

The current measurement section 64 measures a current with the use of the current detection resistance 70, and outputs the measurement result to the control section 61. The temperature detection section 65 measures temperature with the use of the temperature detection device 69, and outputs the measurement result to the control section 61. The temperature measurement result may be used for, for example, a case in which the control section 61 controls charge and discharge at the time of abnormal heat generation or a case in which the control section 61 performs a correction processing at the time of calculating a remaining capacity. The voltage detection section 66 measures a voltage of the secondary battery in the electric power source 62, performs analog-to-digital conversion on the measured voltage, and supplies the resultant to the control section 61.

The switch control section 67 controls operations of the switch section 63 according to signals inputted from the current measurement section 64 and the voltage measurement section 66.

The switch control section 67 executes control so that a charge current is prevented from flowing in a current path of the electric power source 62 by disconnecting the switch section 63 (charge control switch) in the case where, for example, a battery voltage reaches an overcharge detection voltage. Thereby, in the electric power source 62, only discharge is allowed to be performed through the discharging diode. It is to be noted that, for example, in the case where a large current flows at the time of charge, the switch control section 67 blocks the charge current.

Further, the switch control section 67 executes control so that a discharge current is prevented from flowing in the current path of the electric power source 62 by disconnecting the switch section 63 (discharge control switch) in the case where, for example, a battery voltage reaches an overdischarge detection voltage. Thereby, in the electric power source 62, only charge is allowed to be performed through the charging diode. For example, in the case where a large current flows at the time of discharge, the switch control section 67 blocks the discharge current.

It is to be noted that, in the secondary battery, for example, the overcharge detection voltage may be 4.20 V±0.05 V, and the over-discharge detection voltage may be 2.4 V±0.1 V.

The memory 68 may be, for example, an EEPROM as a nonvolatile memory, or the like. The memory 68 may store, for example, numerical values calculated by the control section 61 and information of the secondary battery measured in a manufacturing step (such as an internal resistance in the initial state). It is to be noted that, in the case where the memory 68 stores a full charge capacity of the secondary battery, the control section 61 is allowed to comprehend information such as a remaining capacity.

The temperature detection device 69 measures temperature of the electric power source 62, and outputs the measurement result to the control section 61. The temperature detection device 69 may be, for example, a thermistor or the like.

The cathode terminal 71 and the anode terminal 72 are terminals connected to an external device (such as a notebook personal computer) driven with the use of the battery pack or an external device (such as a battery charger) used for charging the battery pack. The electric power source 62 is charged and discharged through the cathode terminal 71 and the anode terminal 72.

[3-2. Electric Vehicle]

FIG. 10 illustrates a block configuration of a hybrid automobile as an example of electric vehicles. For example, the electric vehicle may include a control section 74, an engine 75, an electric power source 76, a driving motor 77, a differential 78, an electric generator 79, a transmission 80, a clutch 81, inverters 82 and 83, and various sensors 84 in a housing 73 made of metal. In addition thereto, the electric vehicle may include, for example, a front drive shaft 85 and a front tire 86 that are connected to the differential 78 and the transmission 80, a rear drive shaft 87, and a rear tire 88.

The electric vehicle may run with the use of, for example, one of the engine 75 and the motor 77 as a drive source. The engine 75 is a main power source, and may be, for example, a petrol engine. In the case where the engine 75 is used as a power source, drive power (torque) of the engine 75 may be transferred to the front tire 86 or the rear tire 88 through the differential 78, the transmission 80, and the clutch 81 as drive sections, for example. The torque of the engine 75 may also be transferred to the electric generator 79. With the use of the torque, the electric generator 79 generates alternating-current electric power. The alternating-current electric power is converted into direct-current electric power through the inverter 83, and the converted power is stored in the electric power source 76. In contrast, in the case where the motor 77 as a conversion section is used as a power source, electric power (direct-current electric power) supplied from the electric power source 76 is converted into alternating-current electric power through the inverter 82. The motor 77 is driven with the use of the alternating-current electric power. Drive power (torque) obtained by converting the electric power by the motor 77 may be transferred to the front tire 86 or the rear tire 88 through the differential 78, the transmission 80, and the clutch 81 as the drive sections, for example.

It is to be noted that, alternatively, the following mechanism may be adopted. In the mechanism, when speed of the electric vehicle is reduced by an unillustrated brake mechanism, the resistance at the time of speed reduction is transferred to the motor 77 as torque, and the motor 77 generates alternating-current electric power by the torque. It may be preferable that the alternating-current electric power be converted to direct-current electric power through the inverter 82, and the direct-current regenerative electric power be stored in the electric power source 76.

The control section 74 controls operations of the whole electric vehicle, and, for example, may include a CPU and/or the like. The electric power source 76 includes one or more secondary batteries (not illustrated). Alternatively, the electric power source 76 may be connected to an external electric power source, and electric power may be stored by receiving the electric power from the external electric power source. The various sensors 84 may be used, for example, for controlling the number of revolutions of the engine 75 or for controlling opening level (throttle opening level) of an unillustrated throttle valve. The various sensors 84 may include, for example, a speed sensor, an acceleration sensor, an engine frequency sensor, and/or the like.

The description has been given above of the hybrid automobile as an electric vehicle. However, examples of the electric vehicles may include a vehicle (electric automobile) working with the use of only the electric power source 76 and the motor 77 without using the engine 75.

[3-3. Electric Power Storage System]

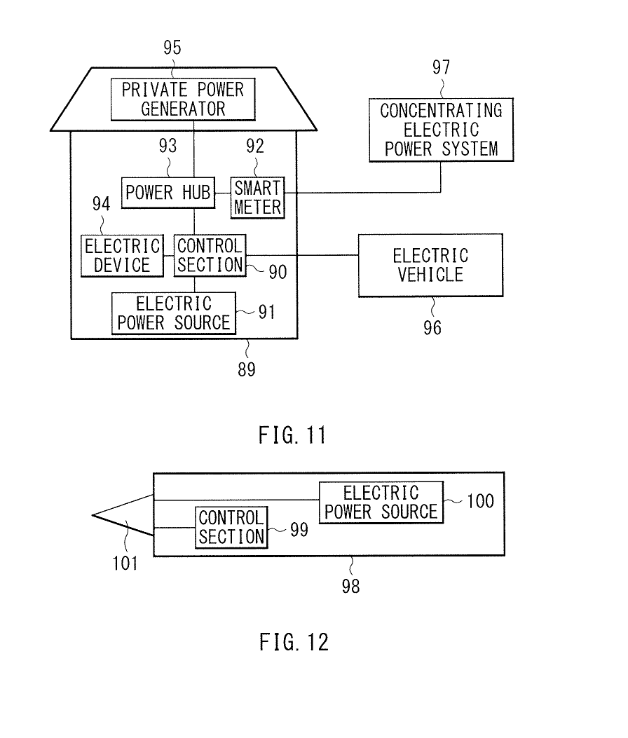

FIG. 11 illustrates a block configuration of an electric power storage system. For example, the electric power storage system may include a control section 90, an electric power source 91, a smart meter 92, and a power hub 93 inside a house 89 such as a general residence and a commercial building.

In this case, the electric power source 91 may be connected to, for example, an electric device 94 arranged inside the house 89, and may be connectable to an electric vehicle 96 parked outside the house 89. Further, for example, the electric power source 91 may be connected to a private power generator 95 arranged inside the house 89 through the power hub 93, and may be connectable to an external concentrating electric power system 97 through the smart meter 92 and the power hub 93.

It is to be noted that the electric device 94 may include, for example, one or more home electric appliances such as a refrigerator, an air conditioner, a television, and a water heater. The private power generator 95 may be, for example, one or more of a solar power generator, a wind-power generator, and the like. The electric vehicle 96 may be, for example, one or more of an electric automobile, an electric motorcycle, a hybrid automobile, and the like. The concentrating electric power system 97 may be, for example, one or more of a thermal power plant, an atomic power plant, a hydraulic power plant, a wind-power plant, and the like.

The control section 90 controls operation of the whole electric power storage system (including a used state of the electric power source 91), and, for example, may include a CPU and/or the like. The electric power source 91 includes one or more secondary batteries (not illustrated). The smart meter 92 may be, for example, an electric power meter compatible with a network arranged in the house 89 demanding electric power, and may be communicable with an electric power supplier. Accordingly, for example, while the smart meter 92 communicates with outside, the smart meter 92 may control the balance between supply and demand in the house 89, and thereby, may allow effective and stable energy supply.

In the electric power storage system, for example, electric power may be stored in the electric power source 91 from the concentrating electric power system 97 as an external electric power source through the smart meter 92 and the power hub 93, and electric power is stored in the electric power source 91 from the private power generator 95 as an independent electric power source through the power hub 93. The electric power stored in the electric power source 91 is supplied to the electric device 94 or to the electric vehicle 96 according to an instruction of the control section 90. Therefore, the electric device 94 becomes operable, and the electric vehicle 96 becomes chargeable. That is, the electric power storage system is a system capable of storing and supplying electric power in the house 89 with the use of the electric power source 91.

The electric power stored in the electric power source 91 is arbitrarily usable. Therefore, for example, electric power is allowed to be stored in the electric power source 91 from the concentrating electric power system 97 in the middle of the night when an electric rate is inexpensive, and the electric power stored in the electric power source 91 is allowed to be used during daytime hours when an electric rate is expensive.

It is to be noted that the foregoing electric power storage system may be arranged for each household (family unit), or may be arranged for a plurality of households (family units).

[3-4. Electric Power Tool]

FIG. 12 illustrates a block configuration of an electric power tool. For example, the electric power tool may be an electric drill, and may include a control section 99 and an electric power source 100 in a tool body 98 made of a plastic material and/or the like. For example, a drill section 101 as a movable section may be attached to the tool body 98 in an operable (rotatable) manner.

The control section 99 controls operations of the whole electric power tool (including a used state of the electric power source 100), and may include, for example, a CPU and/or the like. The electric power source 100 includes one or more secondary batteries (not illustrated). The control section 99 allows electric power to be supplied from the electric power source 100 to the drill section 101 according to operation of an unillustrated operation switch.

### EXAMPLES

Specific Examples of an embodiment of the present application will be described in detail.

### Examples 1-1 to 1-4

The lithium ion secondary battery of a cylindrical type shown in FIGS. 5 and 6 was fabricated by a following procedure.

When fabricating the cathode 21, first, 91 parts by mass of a plurality of cathode active material particles (LiNiO₂), 3 parts by mass of a cathode binder (polyvinylidene fluoride), and 6 parts by mass of a cathode electric conductor (graphite) were mixed to prepare cathode mixture. An average particle size (D50) of powder-like lithium transition metal composite oxide (LiNiO₂) used as the cathode active material particles was 3 μm. The frequency variation ΔF (%) that is an index representing softness of the cathode active material particle was 2.1%. Subsequently, the cathode mixture was diffused into organic solvent (N-methyl-2-pyrolidone) to make paste-like cathode mixture slurry. Subsequently, the cathode mixture slurry was applied uniformly on both surfaces of a belt-like cathode current collector 21A (aluminum foil of 20 μm thick) with use of a coating apparatus, and the applied cathode mixture slurry was dried to form the cathode active material layer 21B. Lastly, the cathode active material layer 21B was compression-molded with use of a roll press machine. By this compression process, the plurality of cathode active material particles included in the cathode active material layer 21B were crushed so that the average particle size reduce gradually in a direction away from the cathode current collector 21A. A layer structure of the cathode active material layer 21B and average particle sizes (μm) in respective layers (in a lower layer and in an upper layer) in a case where the cathode active material layer 21B was equally divided into two were as shown in Table 1.

It is to be noted that, for comparison, the cathode active material layer 21B of a single layer was formed so that softness (the frequency variation ΔF) of the cathode active material particles was varied to allow the average particle size of the cathode active material particles to be uniform, as shown in Table 1. Moreover, the lower layer 201 and the upper layer 202 were formed in separated steps to form the cathode active material layer 21B configured of multiple layers (two layers).

When fabricating the anode 22, first, 90 parts by mass of the anode active material (artificial graphite) and 10 parts by mass of an anode binder (polyvinylidene fluoride) were mixed to prepare anode mixture. Subsequently, the anode mixture was diffused into organic solvent (N-methyl-2-pyrolidone) to make paste-like anode mixture slurry. Subsequently, the anode mixture slurry was applied uniformly on both surfaces of a belt-like anode current collector 22A (electrolyte copper foil of 15 μm thick) with use of a coating apparatus, and the applied anode mixture slurry was dried to form the anode active material layer 22B. Lastly, the anode active material layer 22B was compression-molded with use of a roll press machine.

When preparing the electrolytic solution, electrolyte salt (LiPF₆) was dissolved into a solvent (ethylene carbonate and diethyl carbonate). In this case, a composition of the solvent was set as ethylene carbonate:diethyl carbonate=50:50 in weight ratio, and a content of the electrolyte salt was set as 1 mol/kg with respect to the solvent.

When assembling the secondary battery, first, the cathode lead 25 made of aluminum was welded to the cathode current collector 21A, and the anode lead 26 made of nickel was welded to the anode current collector 22A. Subsequently, the cathode 21 and the anode 22 were layered with the separator 23 (microporous polypropylene film of 25 μm thick) in between and were spirally wound. Thereafter, end portion of the wounded component was fixed with use of an adhesive tape. Thus, the spirally wound electrode body 20 was fabricated. Subsequently, the center pin 24 was inserted in the center of the spirally wound electrode body 20. Subsequently, the spirally wound electrode body 20 was sandwiched between the pair of insulating plates 12 and 13, and was contained in the battery can 11 made of iron and plated with nickel. In this case, one end of the cathode lead 25 was welded to the safety valve mechanism 15, and one end of the anode lead 26 was welded to the battery can 11. Subsequently, the electrolytic solution was injected into the battery can 11 by a depressurization method, and the separator 23 was impregnated with the electrolytic solution. Lastly, at the open end of the battery can 11, the battery cover 14, the safety valve mechanism 15, and the PTC device 16 were fixed by being swaged with the gasket 17. Thus, the secondary battery of a cylindrical type was completed. It is to be noted that, when fabricating the secondary battery, the thickness of the cathode active material layer 21B was adjusted so that lithium metal did not precipitate at the anode 22 in a fully-charged state.

Cycle characteristics and resistance characteristics were examined as battery characteristics of the secondary battery, and results shown in Table 1 were obtained.

When examining the cycle characteristics, the secondary battery was charged and discharged for one cycle in an ambient temperature environment (23° C.) in order to stabilize a state of the battery. Thereafter, the secondary battery was charged and discharged for another cycle in the same environment, and a discharge capacity was measured. Subsequently, the secondary battery was charged and discharged repeatedly until the total number of cycles reached 100, and then the discharge capacity was measured. As a result, cycle retention rate (%), (discharge capacity at the 100th cycle/discharge capacity at 2nd cycle)×100 was calculated. At the time of charging, the secondary battery was charged at a current of 1 C until the upper limit voltage reached 4.2 V, and the secondary battery was discharged at a voltage of 4.2 V until the current reached 0.2 C. At the time of discharging, the secondary battery was discharged at a current of 5 C until the final voltage reached 2.5 V. “0.2 C”, “1 C”, and “5 C” were current values when the battery capacity (theoretical capacity) were discharged out in 5 hours, 1 hours, and 0.2 hours, respectively.

When examining the resistance characteristics, 1 kHz impedance (Ω) of the cathode active material layer 21B was measured before and after the charge and discharge at the 100th cycle described above at the time of examining the cycle characteristics. Based on this result, resistance increase rate (%)=(impedance after charge and discharge/impedance before charge and discharge)×100 was calculated.

TABLE 1

| | Cathode | | Average particle | | | |
|---|---|---|---|---|---|---|
| | active | | size (μm) | | Cycle | Resistance |
| Exam- | material | Layer | Lower | Upper | retention | increase |
| ple | particle | structure | layer | layer | rate (%) | rate (%) |
| 1-1 | LiNiO₂ | Single | 15.5 | 4.9 | 93.1 | 14.2 |
| | | layer | | | | |
| 1-2 | | Single | 15.5 | 15.5 | 86.2 | 22 |
| | | layer | | | | |
| 1-3 | | Single | 4.9 | 4.9 | 84.2 | 22.1 |
| | | layer | | | | |
| 1-4 | | Multiple | 15.5 | 4.9 | 83 | 25 |
| | | layers | | | | |
| | | (Two | | | | |
| | | layers) | | | | |

A high cycle retention rate was achieved when the average particle size of the active material particles in the upper layer was smaller than the average particle size of the active material particle in the lower layer in the cathode active material layer 21B configured of multiple layers (two layers) (Example 1-4). However, an interface was caused between the lower layer and the upper layer. Therefore, the resistance increase rate was largely increased mainly due to interface resistance.

When the average particle size of the cathode active material particles in the upper layer and the average particle size of the cathode active material particles in the lower layer were equivalently large in the cathode active material layer 21B configured of a single layer (Example 1-2), compared with a case where the active material layer 21B configured of multiple layers was formed, the cycle retention rate was slightly increased and the resistance increase rate was slightly suppressed. However, such cycle retention rate and resistance increase rate were not sufficient yet. Similar tendencies were obtained also when the average particle size of the cathode active material particles in the upper layer and the average particle size of the cathode active material particles in the lower layer were equivalently small in the cathode active material layer 21B configured of a single layer (Example 1-3).

As can be seen from the above description, in the series of cases described above, the trade-off relationship was caused in which one of the cycle retention rate and the resistance increase rate was degraded when the other was improved, and such relationship was not resolved.

In contrast, high cycle retention rate was achieved and resistance increase rate was decreased when the average particle size of the cathode active material particles in the upper layer was smaller than the average particle size of the cathode active material particle in the cathode active material layer 21B configured of a single layer (Example 1-1). Accordingly, the trade-off relationship described above was resolved.

### Examples 2-1 to 2-4

As shown in Table 2, secondary batteries were fabricated by a procedure similar to the procedure in Examples 1-1 to 1-4 except that the average particle size (%) of the respective layers in a case where the cathode active material layer 21B was equally divided into three was set, and various characteristics of the secondary batteries were examined.

TABLE 2

| | Cathode | | Average particle size | | | | |
|---|---|---|---|---|---|---|---|
| | active | | (μm) | | | Cycle | Resistance |
| | material | Layer | Lower | Intermediate | Upper | retention | increase |
| Example | particle | structure | layer | layer | layer | rate (%) | rate (%) |
| 2-1 | LiNiO₂ | Single | 15.5 | 10.2 | 3.8 | 98 | 11.7 |
| | | layer | | | | | |
| 2-2 | | Single | 15.5 | 15.5 | 15.5 | 87.7 | 21.4 |
| | | layer | | | | | |
| 2-3 | | Single | 3.8 | 3.8 | 3.8 | 86.8 | 21.5 |
| | | layer | | | | | |
| 2-4 | | Multiple | 15.5 | 10.2 | 3.8 | 84.2 | 23.8 |
| | | layers | | | | | |
| | | (Three | | | | | |
| | | layers) | | | | | |

Also in the case where the cathode active material layer 21B was equally divided into three, a result similar to the result in the case where the cathode active material layer 21B was equally divided into two (Table 1) was obtained. Specifically, when the average particle size of the cathode active material particles in the upper layer was smaller than the average particle size of the cathode active material particles in the lower layer (Example 2-1), high cycle retention rate was achieved and resistance increase rate was suppressed to be low compared to other cases (Examples 2-2 to 2-4). In this case, a favorable result was obtained when the average particle size of the cathode active material particles in the intermediate layer was smaller than the average particle size of the cathode active material particles in the lower layer, and the average particle size of the cathode active material particles in the upper layer was smaller than the average particle size of the cathode active material particles in the intermediate layer.

In particular, when the cathode active material layer 21B was equally divided into three (Example 2-1), cycle retention rate was further increased and resistance increase rate was further decreased compared to the case where the cathode active material layer 21B was equally divided into two (Example 1-1).

### Examples 3-1 to 3-5

As shown in Table 3, secondary batteries were fabricated by a procedure similar to the procedure in Example 1-1 except that the frequency variation ΔF was varied in the case where the cathode active material layer 21B was equally divided into two, and various characteristics of the secondary batteries were examined.

TABLE 3

| | Cathode | | | Average particle | | | |
|---|---|---|---|---|---|---|---|
| | active | | Frequency | size (μm) | | Cycle | Resistance |
| | material | Layer | variation | Lower | Upper | retention | increase |
| Example | particle | structure | ΔF (%) | layer | layer | rate (%) | rate (%) |
| 3-1 | LiNiO₂ | Single | 0.9 | 17 | 7 | 83 | 18.2 |
| 3-2 | | layer | 1.1 | 16.1 | 6.1 | 92.1 | 14.3 |
| 1-1 | | | 2.1 | 15.5 | 4.9 | 93.1 | 14.2 |
| 3-3 | | | 10.6 | 14 | 4.2 | 92.5 | 14.1 |
| 3-4 | | | 15.8 | 13 | 3.7 | 92.4 | 13.9 |
| 3-5 | | | 16.1 | 12.7 | 3.3 | 84.7 | 18 |

As the frequency variation ΔF was increased, the cycle retention rate increased and then decreased, and the resistance increase rate decreased and then increased. In this case, high cycle retention rate and low resistance increase rate were obtained when the frequency variation ΔF was from 0.9% to 16.1% both inclusive. When the frequency variation ΔF was from 1.1% to 15.8% both inclusive, the cycle retention rate further increased and the resistance increase rate further decreased.

### Examples 4-1 to 4-5

As shown in Table 4, secondary batteries were fabricated by a procedure similar to the procedure in Examples 2-1 and 3-1 to 3-5 except that the frequency variation ΔF was varied in the case where the cathode active material layer 21B was equally divided into three, and various characteristics of the secondary batteries were examined.

TABLE 4

| | Cathode | | | | | | | |
|---|---|---|---|---|---|---|---|---|
| | active | | Frequency | Average particle size (μm) | | | Cycle | Resistance |
| | material | Layer | variation | Lower | Intermediate | Upper | retention | increase |
| Example | particle | structure | ΔF (%) | layer | layer | layer | rate (%) | rate (%) |
| 4-1 | LiNiO₂ | Single | 0.9 | 16.3 | 11.2 | 4.6 | 87.7 | 21.4 |
| 4-2 | | layer | 1.1 | 16 | 10.7 | 4.2 | 97 | 12.1 |
| 2-1 | | | 2.1 | 15.5 | 10.2 | 3.8 | 98 | 11.7 |
| 4-3 | | | 10.6 | 14 | 9.6 | 3.6 | 96 | 12.3 |
| 4-4 | | | 15.8 | 13.5 | 9.2 | 3.2 | 95.2 | 12.7 |
| 4-5 | | | 16.1 | 12.8 | 8.8 | 2.9 | 86.6 | 21.2 |

Also in the case where the cathode active material layer 21B was equally divided into three, a result similar to the result in the case where the cathode active material layer 21B was equally divided into two (Table 3) was obtained. Specifically, high cycle retention rate and low resistance increase rate were obtained when the frequency variation ΔF was from 0.9% to 16.1% both inclusive. Further higher cycle retention rate and further lower resistance increase rate were obtained when the frequency variation ΔF was from 1.1% to 15.8% both inclusive.

### Examples 5-1 to 5-19

As shown in Table 5, secondary batteries were fabricated by a procedure similar to the procedure in Example 1-1 except that a series of parameters were set in the case where the cathode active material layer 21B was equally divided into two, and various characteristics of the secondary batteries were examined. The series of parameters were a thickness (μm) of the cathode active material layer 21B, volume density (g/cm³) thereof, a ratio of F1/F2, a ratio of F3/F4, and a ratio of (F1/F2)/(F3/F4).

TABLE 5
Cathode active material particle: LiNiO₂, Layer structure: Single layer
Average particle size (equally divided into two): Lower layer =
15.5 μm, Upper layer = 4.9 μm

| | | | | | | | Resis- |
|---|---|---|---|---|---|---|---|
| | Thick- | Volume | | | Ratio | Cycle | tance |
| Exam- | ness | density | Ratio | Ratio | (F1/F2)/ | retention | increase |
| ple | (μm) | (g/cm³) | F1/F2 | F3/F4 | (F3/F4) | rate (%) | rate (%) |
| 5-1 | 80 | 2.7 | 5.66 | 7.91 | 0.72 | 92.2 | 14 |
| 5-2 | 80 | 3.6 | 0.2 | 0.35 | 0.57 | 90.2 | 16.1 |
| 1-1 | 80 | 3.3 | 2.01 | 3.02 | 0.67 | 93.1 | 14.2 |
| 5-3 | 80 | 2.7 | 3.52 | 5.88 | 0.6 | 94 | 13.3 |
| 5-4 | 80 | 2.7 | 2.77 | 4.01 | 0.69 | 94 | 14.3 |
| 5-5 | 80 | 2.7 | 2.16 | 2.87 | 0.75 | 90.2 | 14.2 |
| 5-6 | 130 | 3.3 | 0.85 | 1.08 | 0.79 | 90.2 | 15 |
| 5-7 | 130 | 3.3 | 1.56 | 2.01 | 0.78 | 91.4 | 14.2 |
| 5-8 | 130 | 3.3 | 1.2 | 1.88 | 0.64 | 90.3 | 15.1 |
| 5-9 | 130 | 3.3 | 1.09 | 1.66 | 0.66 | 90.5 | 15.4 |
| 5-10 | 130 | 3.3 | 2.89 | 4.02 | 0.72 | 90.2 | 15.3 |
| 5-11 | 180 | 2.7 | 2.56 | 3.45 | 0.74 | 89.2 | 15.2 |
| 5-12 | 180 | 2.7 | 7 | 9 | 0.78 | 92.2 | 14.3 |
| 5-13 | 180 | 3.6 | 0.62 | 0.78 | 0.79 | 89.4 | 15.2 |
| 5-14 | 75 | 3.3 | 1.13 | 2.31 | 0.49 | 83.4 | 18.2 |
| 5-15 | 190 | 3.3 | 6.45 | 7.98 | 0.81 | 82.3 | 18.1 |
| 5-16 | 80 | 2.6 | 7.1 | 9.1 | 0.78 | 82.4 | 18.1 |
| 5-17 | 80 | 3.7 | 0.19 | 0.34 | 0.56 | 80.4 | 19 |
| 5-18 | 80 | 3.6 | 0.45 | 0.34 | 1.32 | 82.1 | 19.3 |
| 5-19 | 180 | 2.7 | 7.89 | 9.2 | 0.86 | 80.4 | 19.2 |

When the average particle size of the cathode active material particles in the upper layer was smaller than the average particle size of the cathode active material particles in the lower layer in the cathode active material layer 21B configured of a single layer, cycle retention rate and resistance increase rate were varied in accordance with the series of parameters. In this case, the cycle retention rate was further increased and the resistance increase rate was further decreased when following series of conditions were satisfied at the same time. The series of conditions were: thickness=80 μm to 180 μm; volume density=2.7 g/cm³ to 3.6 g/cm³; ratio F1/F2=0.2 to 7; ratio F3/F4=0.35 to 9; and ratio (F1/F2)/(F3/F4)=0.57 to 0.79.

### Examples 6-1 to 6-20

As shown in Table 6, secondary batteries were fabricated by a procedure similar to the procedure in Example 2-1 except that a series of parameters were set in the case where the cathode active material layer 21B was equally divided into three, and various characteristics of the secondary batteries were examined. The series of parameters were a thickness (μm) of the cathode active material layer 21B, volume density (g/cm³) thereof, a ratio of F1/F2, a ratio of F5/F6, and a ratio of F7/F8.

TABLE 6
Cathode active material particle: LiNiO₂, Layer structure: Single layer
Average particle size (Equally divided into three): Lower layer =
15.5 μm, Intermediate layer = 10.2 μm, Upper layer = 3.8 μm

| | | | | | | | Resis- |
|---|---|---|---|---|---|---|---|
| | Thick- | Volume | | | | Cycle | tance |
| Exam- | ness | density | Ratio | Ratio | Ratio | retention | increase |
| ple | (μm) | (g/cm³) | F1/F2 | F5/F6 | F7/F8 | rate (%) | rate (%) |
| 6-1 | 80 | 2.7 | 5.66 | 6.5 | 10.52 | 98.9 | 10.9 |
| 6-2 | 80 | 3.6 | 0.2 | 0.27 | 0.47 | 97.4 | 12.2 |
| 2-1 | 80 | 3.3 | 2.01 | 2.41 | 4.02 | 98 | 11.7 |
| 6-3 | 80 | 2.7 | 3.52 | 4.52 | 7.82 | 97.8 | 11.6 |
| 6-4 | 80 | 2.7 | 2.77 | 3.25 | 5.33 | 98.3 | 10.8 |
| 6-5 | 80 | 2.7 | 2.16 | 2.41 | 3.82 | 97.3 | 11.9 |
| 6-6 | 130 | 3.3 | 0.85 | 0.92 | 1.44 | 97.2 | 11.9 |
| 6-7 | 130 | 3.3 | 1.56 | 1.71 | 2.67 | 97.1 | 11.8 |
| 6-8 | 130 | 3.3 | 1.2 | 1.48 | 2.5 | 97.1 | 11.9 |
| 6-9 | 130 | 3.3 | 1.09 | 1.32 | 2.21 | 97.3 | 11.8 |
| 6-10 | 130 | 3.3 | 2.89 | 3.31 | 5.35 | 97.8 | 11.5 |
| 6-11 | 180 | 2.7 | 2.56 | 2.88 | 4.59 | 97.3 | 11.4 |
| 6-12 | 180 | 2.7 | 7 | 7.65 | 11.97 | 97.8 | 11.3 |
| 6-13 | 180 | 3.6 | 0.62 | 0.67 | 1.04 | 97.2 | 11.7 |
| 6-14 | 75 | 3.3 | 1.13 | 2.31 | 12.8 | 93.1 | 13.4 |
| 6-15 | 190 | 3.3 | 6.45 | 7.98 | 11.8 | 90.2 | 14.3 |
| 6-16 | 80 | 2.6 | 7.1 | 9.1 | 11.9 | 92 | 14.2 |
| 6-17 | 80 | 3.7 | 0.19 | 0.34 | 0.44 | 91.1 | 15.1 |
| 6-18 | 180 | 2.7 | 7.89 | 9.2 | 11.8 | 90.4 | 15 |
| 6-19 | 80 | 3.6 | 0.2 | 0.57 | 0.4 | 91.3 | 15.2 |
| 6-20 | 180 | 2.7 | 7 | 0.78 | 12.1 | 90 | 15.2 |

When the average particle size of the cathode active material particles in the upper layer is smaller than the average particle size of the cathode active material particles in the lower layer in the cathode active material layer 21B configured of a single layer, cycle retention rate and resistance increase rate were varied in accordance with a series of parameters. In this case, the cycle retention rate was further increased and the resistance increase rate was further decreased when following series of conditions were satisfied at the same time. The series of conditions were: thickness=80 μm to 180 μm; volume density=2.7 g/cm³ to 3.6 g/cm³; ratio F1/F2=0.2 to 7; ratio F5/F6=0.27 to 7.65; and ratio F7/F8=0.47 to 11.97.

As can be seen from the results shown in Tables 1 to 6, superior battery characteristics were achieved, in the case where the active material layer configured of a single layer was divided in the thickness direction, when the average particle size of the active material particles in the second layer farther from the current collector is smaller than the average particle size of the active material particles in the first layer closer to the current collector.

The present application has been described hereinabove referring to an embodiment and Examples. However, the present application is not limited to those described in the above embodiment and Examples, and may be variously modified. For example, the description has been given with the specific examples of the case in which the battery structure is of the cylindrical type or of the laminated film type, and the battery device has the spirally wound structure. However, the structure of the secondary battery of the present application is not limited thereto. The secondary battery of the present application is similarly applicable to a battery having other battery structure such as a square-type battery, a coin-type battery, and a button-type battery, or a battery in which the battery device has other structure such as a laminated structure.

Also, the electrode for a secondary battery according to an embodiment of the present application is applied not limitedly to a secondary battery, but may be applied to other electrochemical device. Specific examples of other electrochemical device may include a capacitor.

Concerning a range of the thickness of the cathode active material layer, description has been provided of an appropriate range derived from the results of Examples. However, such description does not completely deny a possibility that the thickness may be out of the above-described range. Specifically, the above-described appropriate range is a range that is especially favorable in obtaining the effect of the present application. Therefore, the thickness may be out of the above-described range in some degree as long as the effect of the present application is achievable. The same is applicable to any other of the series of parameters such as volume density.

It is possible to achieve at least the following configurations from the above-described example embodiments and the modifications of the disclosure.

(1) A secondary battery including:

a cathode;

an anode; and

a non-aqueous electrolytic solution,

the cathode including

a cathode current collector, and

a cathode active material layer provided on the cathode current collector, and

the cathode active material layer being configured of a single layer and including a plurality of cathode active material particles, wherein,

when the cathode active material layer is divided, at one or more arbitrary positions, into two or more layers, an average particle size of the cathode active material particles in an uppermost layer is smaller than an average particle size of the cathode active material particles in a lowermost layer in the two or more layers of the divided cathode active material layer.

(2) The secondary battery according to (1), wherein, when the cathode active material layer is divided, in an arbitrary position, into two layers that are a lower layer and an upper layer in order from the cathode current collector, an average particle size of the cathode active material particles in the upper layer is smaller than an average particle size of the cathode active material particles in the lower layer.
(3) The secondary battery according to (2), wherein, when the lower layer is subjected to a uniaxial pressing process at a pressure of 30 MPa in a thickness direction, variation before and after the uniaxial pressing process in frequency (percent) of a minimum peak detected by measuring particle size distribution (volume distribution) in the lower layer is equal to or higher than 1.1 percent and equal to or lower than 15.8 percent.
(4) The secondary battery according to (2) or (3), wherein

(A) a thickness of the cathode active material layer is equal to or larger than 80 micrometers and equal to or smaller than 180 micrometers,

(B) a volume density of the cathode active material layer is equal to or larger than 2.7 grams per cubic meter and equal to or smaller than 3.6 grams per cubic meter,

(C) a first peak having relatively-large frequency (percent) and a second peak having relatively-small frequency (percent) are detected by measuring particle size distribution (volume distribution) of the cathode active material particles in the cathode active material layer,

a ratio F1/F2 of frequency F1 of the first peak to frequency F2 of the second peak is equal to or larger than 0.2 and equal to or smaller than 7,

(D) a third peak having relatively-large frequency (percent) and a fourth peak having relatively-small frequency (percent) are detected by measuring particle size distribution (volume distribution) of the cathode active material particles in the lower layer,

a ratio F3/F4 of frequency F3 of the third peak to frequency F4 of the fourth peak is equal to or larger than 0.35 and equal to or smaller than 9, and

(E) a ratio (F1/F2)/(F3/F4) of the ratio F1/F2 to the ratio F3/F4 is equal to or larger than 0.57 and equal to or smaller than 0.79.

(5) The secondary battery according to (1), wherein, when the cathode active material layer is divided, at arbitrary positions, into three layers that are a lower layer, a middle layer, and an upper layer in order from the cathode current collector, an average particle size of the cathode active material particles in the upper layer is smaller than an average particle size of the cathode active material particles in the lower layer.
(6) The secondary battery according to (5), wherein

an average particle size of the cathode active material particles in the middle layer is smaller than the average particle size of the cathode active material particles in the lower layer, and

the average particle size of the cathode active material particles in the upper layer is smaller than the average particle size of the cathode active material particles in the middle layer.

(7) The secondary battery according to (5) or (6), wherein, when the lower layer is subjected to a uniaxial pressing process at a pressure of 30 MPa in a thickness direction, variation before and after the uniaxial pressing process in frequency (percent) of a minimum peak detected by measuring particle size distribution (volume distribution) in the lower layer is equal to or higher than 1.1 percent and equal to or lower than 15.8 percent.
(8) The secondary battery according to any one of (5) to (7), wherein

(F) a thickness of the cathode active material layer is equal to or larger than 80 micrometers and equal to or smaller than 180 micrometers,

(G) a volume density of the cathode active material layer is equal to or larger than 2.7 grams per cubic meter and equal to or smaller than 3.6 grams per cubic meter,

(H) a first peak having relatively-large frequency (percent) and a second peak having relatively-small frequency (percent) are detected by measuring particle size distribution (volume distribution) of the cathode active material particles in the cathode active material layer,

a ratio F1/F2 of frequency F1 of the first peak to frequency F2 of the second peak is equal to or larger than 0.2 and equal to or smaller than 7,

(I) a fifth peak having relatively-large frequency (percent) and a sixth peak having relatively-small frequency (percent) are detected by measuring particle size distribution (volume distribution) of the cathode active material particles in the lower layer and the middle layer,

a ratio F5/F6 of frequency F5 of the fifth peak to frequency F6 of the sixth peak is equal to or larger than 0.27 and equal to or smaller than 7.65, and

(J) a seventh peak having relatively-large frequency (percent) and an eighth peak having relatively-small frequency (percent) are detected by measuring particle size distribution (volume distribution) of the cathode active material particles in the lower layer,

a ratio F7/F8 of frequency F7 of the seventh peak to frequency F8 of the eighth peak is equal to or larger than 0.47 and equal to or smaller than 11.97.

(9) The secondary battery according to any one of (1) to (8), wherein an average particle size of the cathode active material particles in the cathode active material layer decreases gradually in a direction away from the cathode current collector.
(10) The secondary battery according to any one of (1) to (9), wherein the cathode active material particles include one or more of compounds represented by following Formula (1),

LiₐNi_{b}M_{c}O_{d} (1)

where M is one or more of cobalt (Co), iron (Fe), manganese (Mn), copper (Cu), zinc (Zn), aluminum (Al), chromium (Cr), vanadium (V), titanium (Ti), magnesium (Mg), and zirconium (Zr), and

a to d satisfy 0.8<a<1.2, 0.45≦b≦1, 0≦c≦1, 0≦b+c≦1, and 0<d<3.

(11) The secondary battery according to any one of (1) to (10), wherein the cathode active material layer includes a cathode binder.
(12) The secondary battery according to any one of (1) to (11), wherein the secondary battery is a lithium secondary battery.
(13) A secondary battery including:

a cathode;

an anode; and

a non-aqueous electrolytic solution,

the cathode including

a cathode current collector, and

a cathode active material layer provided on the cathode current collector, and

the cathode active material layer being configured of a single layer and including a plurality of cathode active material particles, wherein

distribution of average particle size of the cathode active material particles in a thickness direction of the cathode active material layer has gradient that allows the average particle size of the cathode active material particles to decrease gradually in a direction away from the cathode current collector.

(14) An electrode including:

a current collector; and

an active material layer provided on the current collector,

the active material layer being configured of a single layer and including a plurality of active material particles, wherein,

when the cathode active material layer is divided, at one or more arbitrary positions, into two or more layers, an average particle size of the cathode active material particles in an uppermost layer is smaller than an average particle size of the cathode active material particles in a lowermost layer in the two or more layers of the divided cathode active material layer.

(15) A battery pack including:

the secondary battery according to any one of (1) to (13);

a control section configured to control operation of the secondary battery; and

a switch section configured to switch the operation of the secondary battery according to an instruction of the control section.

(16) An electric vehicle including:

the secondary battery according to any one of (1) to (13);

a conversion section configured to convert electric power supplied from the secondary battery into drive power;

a drive section configured to operate according to the drive power; and

a control section configured to control operation of the secondary battery.

(17) An electric power storage system including:

the secondary battery according to any one of (1) to (13);

one or more electric devices configured to be supplied with electric power from the secondary battery; and

a control section configured to control supplying of the electric power from the secondary battery to the one or more electric devices.

(18) An electric power tool including:

the secondary battery according to any one of (1) to (13); and

a movable section configured to be supplied with electric power from the secondary battery.

(19) An electronic apparatus including

the secondary battery according to any one of (1) to (13) as an electric power supply source.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A secondary battery comprising:
a cathode;
an anode; and
a non-aqueous electrolytic solution,
the cathode including
a cathode current collector, and
a cathode active material layer provided on the cathode current collector, and
the cathode active material layer being configured of a single layer and including a plurality of cathode active material particles, wherein,
when the cathode active material layer is divided, at one or more arbitrary positions, into two or more layers, an average particle size of the cathode active material particles in an uppermost layer is smaller than an average particle size of the cathode active material particles in a lowermost layer in the two or more layers of the divided cathode active material layer.

2. The secondary battery according to claim 1, wherein, when the cathode active material layer is divided, in an arbitrary position, into two layers that are a lower layer and an upper layer in order from the cathode current collector, an average particle size of the cathode active material particles in the upper layer is smaller than an average particle size of the cathode active material particles in the lower layer.

3. The secondary battery according to claim 2, wherein, when the lower layer is subjected to a uniaxial pressing process at a pressure of 30 MPa in a thickness direction, variation before and after the uniaxial pressing process in frequency (percent) of a minimum peak detected by measuring particle size distribution (volume distribution) in the lower layer is equal to or higher than 1.1 percent and equal to or lower than 15.8 percent.

4. The secondary battery according to claim 2, wherein
(A) a thickness of the cathode active material layer is equal to or larger than 80 micrometers and equal to or smaller than 180 micrometers,
(B) a volume density of the cathode active material layer is equal to or larger than 2.7 grams per cubic meter and equal to or smaller than 3.6 grams per cubic meter,
(C) a first peak having relatively-large frequency (percent) and a second peak having relatively-small frequency (percent) are detected by measuring particle size distribution (volume distribution) of the cathode active material particles in the cathode active material layer,
a ratio F1/F2 of frequency F1 of the first peak to frequency F2 of the second peak is equal to or larger than 0.2 and equal to or smaller than 7,
(D) a third peak having relatively-large frequency (percent) and a fourth peak having relatively-small frequency (percent) are detected by measuring particle size distribution (volume distribution) of the cathode active material particles in the lower layer,
a ratio F3/F4 of frequency F3 of the third peak to frequency F4 of the fourth peak is equal to or larger than 0.35 and equal to or smaller than 9, and
(E) a ratio (F1/F2)/(F3/F4) of the ratio F1/F2 to the ratio F3/F4 is equal to or larger than 0.57 and equal to or smaller than 0.79.

5. The secondary battery according to claim 1, wherein, when the cathode active material layer is divided, at arbitrary positions, into three layers that are a lower layer, a middle layer, and an upper layer in order from the cathode current collector, an average particle size of the cathode active material particles in the upper layer is smaller than an average particle size of the cathode active material particles in the lower layer.

6. The secondary battery according to claim 5, wherein
an average particle size of the cathode active material particles in the middle layer is smaller than the average particle size of the cathode active material particles in the lower layer, and
the average particle size of the cathode active material particles in the upper layer is smaller than the average particle size of the cathode active material particles in the middle layer.

7. The secondary battery according to claim 5, wherein, when the lower layer is subjected to a uniaxial pressing process at a pressure of 30 MPa in a thickness direction, variation before and after the uniaxial pressing process in frequency (percent) of a minimum peak detected by measuring particle size distribution (volume distribution) in the lower layer is equal to or higher than 1.1 percent and equal to or lower than 15.8 percent.

8. The secondary battery according to claim 5, wherein
(F) a thickness of the cathode active material layer is equal to or larger than 80 micrometers and equal to or smaller than 180 micrometers,
(G) a volume density of the cathode active material layer is equal to or larger than 2.7 grams per cubic meter and equal to or smaller than 3.6 grams per cubic meter,
(H) a first peak having relatively-large frequency (percent) and a second peak having relatively-small frequency (percent) are detected by measuring particle size distribution (volume distribution) of the cathode active material particles in the cathode active material layer,
a ratio F1/F2 of frequency F1 of the first peak to frequency F2 of the second peak is equal to or larger than 0.2 and equal to or smaller than 7,
(I) a fifth peak having relatively-large frequency (percent) and a sixth peak having relatively-small frequency (percent) are detected by measuring particle size distribution (volume distribution) of the cathode active material particles in the lower layer and the middle layer,
a ratio F5/F6 of frequency F5 of the fifth peak to frequency F6 of the sixth peak is equal to or larger than 0.27 and equal to or smaller than 7.65, and
(J) a seventh peak having relatively-large frequency (percent) and an eighth peak having relatively-small frequency (percent) are detected by measuring particle size distribution (volume distribution) of the cathode active material particles in the lower layer,
a ratio F7/F8 of frequency F7 of the seventh peak to frequency F8 of the eighth peak is equal to or larger than 0.47 and equal to or smaller than 11.97.

9. The secondary battery according to claim 1, wherein an average particle size of the cathode active material particles in the cathode active material layer decreases gradually in a direction away from the cathode current collector.

10. The secondary battery according to claim 1, wherein the cathode active material particles include one or more of compounds represented by following Formula (1),
LiaNibMcOd (1)
where M is one or more of cobalt (Co), iron (Fe), manganese (Mn), copper (Cu), zinc (Zn), aluminum (Al), chromium (Cr), vanadium (V), titanium (Ti), magnesium (Mg), and zirconium (Zr), and
a to d satisfy 0.8<a<1.2, 0.45≦b≦1, 0≦c≦1, 0≦b+c≦1, and 0<d<3.

11. The secondary battery according to claim 1, wherein the cathode active material layer includes a cathode binder.

12. The secondary battery according to claim 1, wherein the secondary battery is a lithium secondary battery.

13. A secondary battery comprising:
a cathode;
an anode; and
a non-aqueous electrolytic solution,
the cathode including
a cathode current collector, and
a cathode active material layer provided on the cathode current collector, and
the cathode active material layer being configured of a single layer and including a plurality of cathode active material particles, wherein
distribution of average particle size of the cathode active material particles in a thickness direction of the cathode active material layer has gradient that allows the average particle size of the cathode active material particles to decrease gradually in a direction away from the cathode current collector.

14. An electrode comprising:
a current collector; and
an active material layer provided on the current collector,
the active material layer being configured of a single layer and including a plurality of active material particles, wherein,
when the cathode active material layer is divided, at one or more arbitrary positions, into two or more layers, an average particle size of the cathode active material particles in an uppermost layer is smaller than an average particle size of the cathode active material particles in a lowermost layer in the two or more layers of the divided cathode active material layer.

15. A battery pack comprising:
a secondary battery;
a control section configured to control operation of the secondary battery; and
a switch section configured to switch the operation of the secondary battery according to an instruction of the control section,
the secondary battery including
a cathode,
an anode, and
a non-aqueous electrolytic solution,
the cathode including
a cathode current collector, and
a cathode active material layer provided on the cathode current collector, and
the cathode active material layer being configured of a single layer and including a plurality of cathode active material particles, wherein,
when the cathode active material layer is divided, at one or more arbitrary positions, into two or more layers, an average particle size of the cathode active material particles in an uppermost layer is smaller than an average particle size of the cathode active material particles in a lowermost layer in the two or more layers of the divided cathode active material layer.

16. An electric vehicle comprising:
a secondary battery;
a conversion section configured to convert electric power supplied from the secondary battery into drive power;
a drive section configured to operate according to the drive power; and
a control section configured to control operation of the secondary battery,
the secondary battery including
a cathode,
an anode, and
a non-aqueous electrolytic solution,
the cathode including
a cathode current collector, and
a cathode active material layer provided on the cathode current collector, and
the cathode active material layer being configured of a single layer and including a plurality of cathode active material particles, wherein,
when the cathode active material layer is divided, at one or more arbitrary positions, into two or more layers, an average particle size of the cathode active material particles in an uppermost layer is smaller than an average particle size of the cathode active material particles in a lowermost layer in the two or more layers of the divided cathode active material layer.

17. An electric power storage system comprising:
a secondary battery;
one or more electric devices configured to be supplied with electric power from the secondary battery; and
a control section configured to control supplying of the electric power from the secondary battery to the one or more electric devices,
the secondary battery including
a cathode,
an anode, and
a non-aqueous electrolytic solution,
the cathode including
a cathode current collector, and
a cathode active material layer provided on the cathode current collector, and
the cathode active material layer being configured of a single layer and including a plurality of cathode active material particles, wherein,
when the cathode active material layer is divided, at one or more arbitrary positions, into two or more layers, an average particle size of the cathode active material particles in an uppermost layer is smaller than an average particle size of the cathode active material particles in a lowermost layer in the two or more layers of the divided cathode active material layer.

18. An electric power tool comprising:
a secondary battery; and
a movable section configured to be supplied with electric power from the secondary battery,
the secondary battery including
a cathode,
an anode, and
a non-aqueous electrolytic solution,
the cathode including
a cathode current collector, and
a cathode active material layer provided on the cathode current collector, and
the cathode active material layer being configured of a single layer and including a plurality of cathode active material particles, wherein,
when the cathode active material layer is divided, at one or more arbitrary positions, into two or more layers, an average particle size of the cathode active material particles in an uppermost layer is smaller than an average particle size of the cathode active material particles in a lowermost layer in the two or more layers of the divided cathode active material layer.

19. An electronic apparatus comprising
a secondary battery as an electric power supply source,
the secondary battery including
a cathode,
an anode, and
a non-aqueous electrolytic solution,
the cathode including
a cathode current collector, and
a cathode active material layer provided on the cathode current collector, and
the cathode active material layer being configured of a single layer and including a plurality of cathode active material particles, wherein,
when the cathode active material layer is divided, at one or more arbitrary positions, into two or more layers, an average particle size of the cathode active material particles in an uppermost layer is smaller than an average particle size of the cathode active material particles in a lowermost layer in the two or more layers of the divided cathode active material layer.
